(19) United States
(12) Patent Application Publication
(10) Pub. No.: US 2025/0336020 A1
(43) Pub. Date: Oct. 30, 2025

(54) UTILIZING TRIGGERING EVENTS TO INITIATE DYNAMIC COORDINATION OF GRAPHICAL USER INTERFACES ACROSS DEVICES

(71) Applicant: Lyft, Inc., San Francisco, CA (US)

(72) Inventors: Kyong Tak Cho, Santa Clara, CA (US); David Walter Hildebrand, Oakland, CA (US); Young Kyo Kim, San Francisco, CA (US); Alison Frances Marlin, Berkeley, CA (US); Brian David Ng, Santa Clara, CA (US); Bomee Park, Oakland, CA (US); Suresh Pragada, Dublin, CA (US); Neil Pradip Shah, San Carlos, CA (US)

(21) Appl. No.: 19/263,484

(22) Filed: Jul. 9, 2025

Related U.S. Application Data
(63) Continuation of application No. 16/834,158, filed on Mar. 30, 2020, now abandoned.

(51) Int. Cl. G06Q 50/40; G01C 21/34; G06F 16/335; G06Q 10/02; H04L 67/56; H04W 4/02; H04W 4/021

(52) U.S. Cl. CPC G06Q 50/40; G01C 21/3438; G06F 16/335; G06Q 10/02; H04L 67/56; H04W 4/021; H04W 4/023

(57) ABSTRACT

This disclosure describes a proxy matching system that facilitates proxy transportation requests for a proxy rider where the proxy transportation request is generated from a requestor device. For example, the proxy matching system provides an integrated user interface to a requestor device that enables the requestor to generate transportation requests for either themselves or another user (e.g., a proxy rider) of a transportation matching system. For a proxy transportation request, the proxy matching system can identify a transportation provider that provides a transportation service to the proxy rider as well as provide rider identification information to the transportation provider. In this manner, the proxy matching system provides a seamless experience where the transportation provider can interact with the rider as if the rider directly generated the request. Further, the proxy matching system can keep the requestor device updated with the current status of the transportation service.

### CROSS-REFERENCE TO RELATED APPLICATIONS

This application is a continuation of U.S. patent application Ser. No. 16/834,158, filed on Mar. 30, 2020. The aforementioned application is hereby incorporated by reference in its entirety.

### BACKGROUND

In recent years, both the popularity and usage of on-demand transportation provider systems have increased. Indeed, the proliferation of web and mobile applications has enabled requesting devices to utilize on-demand transportation provider systems to identify matching provider devices and then coordinate across computing devices to initiate transportation from one geographic location to another. Despite these advances, conventional on-demand transportation provider systems suffer from a number of technical drawbacks particularly in relation to efficiency, accuracy, and flexibility of implementing computer systems in indirectly generating and fulfilling transportation requests.

### SUMMARY

One or more embodiments described herein provide benefits and/or solve one or more of the foregoing or other problems in the art with methods, non-transitory computer-readable media, and systems that utilize user interfaces at a requestor device to flexibly, accurately, and efficiently generate transportation matches between provider devices and proxy rider devices. For example, based on interaction with a requestor device, the disclosed systems can generate a proxy transportation request for providing transportation services for another user (i.e., a proxy rider with a corresponding rider device). In response, the disclosed systems can identify a provider device that can fulfill the proxy transportation request for the proxy rider and rider device.

Moreover, before, during, and after the transportation service, the disclosed systems can generate coordinated user interfaces across the requestor device, the rider device, and the provider device. To illustrate, the disclosed systems can intelligently provide a user interface to the provider device such that it appears to the provider that the rider device, rather than the requestor device, generated the proxy transportation request. Additionally, the disclosed systems can provide synchronized user interfaces to both the requestor device and the rider device upon generating the proxy transportation request and throughout the ride (i.e., transportation service). In this manner, the disclosed systems can flexibly, accurately, and efficiently generate and fulfill transportation matches between requestor devices, rider devices, and provider devices.

Additional features and advantages of one or more implementations of the present disclosure are outlined in the following description, and in part will be obvious from the description, or may be learned by the practice of such example implementations.

### BRIEF DESCRIPTION OF THE DRAWINGS

The detailed description refers to the drawings briefly described below.

FIG. 1 illustrates a block diagram of a system environment for implementing a proxy matching system in accordance with one or more embodiments.

FIG. 2 illustrates an overview of the proxy matching system generating and fulfilling transportation requests submitted by a requestor for a proxy rider in accordance with one or more embodiments.

FIG. 3 illustrates a sequence flow diagram of multiple devices communicating to complete a transportation request submitted at a requestor device for a proxy rider in accordance with one or more embodiments.

FIGS. 4A-4H illustrate graphical user interfaces of a requestor device, a rider device, and a provider device with respect to generating transportation requests submitted by a requestor for a proxy rider in accordance with one or more embodiments.

FIG. 5 illustrates a state diagram of detecting a proxy transportation request at a requestor device in accordance with one or more embodiments.

FIGS. 6A-6C illustrate graphical user interfaces of detecting a proxy transportation request at a requestor device in accordance with one or more embodiments.

FIG. 7 illustrates a state diagram of adding and selecting proxy riders for a transportation request at a requestor device in accordance with one or more embodiments.

FIGS. 8A-8C illustrate graphical user interfaces for maintaining a list of proxy riders at a requestor device in accordance with one or more embodiments.

FIG. 9 illustrates a diagram of determining available features for a requestor device and a rider device with respect to a proxy transportation request in accordance with one or more embodiments.

FIGS. 10A-10D illustrate graphical user interfaces for providing different selectable transportation options to a requestor device and a rider device with respect to a proxy transportation request in accordance with one or more embodiments.

FIG. 11 illustrates a block diagram of a computing device including various components of a proxy matching system in accordance with one or more embodiments.

FIG. 12 illustrates a flow diagram of a series of acts for facilitating transportation requests from a requestor device for providing a transportation service for a proxy rider in accordance with one or more embodiments.

FIG. 13 illustrates a block diagram of a computing device for implementing one or more embodiments of the present disclosure.

FIG. 14 illustrates an example environment for a transportation matching system in accordance with one or more embodiments.

### DETAILED DESCRIPTION

This disclosure describes a proxy matching system that utilizes interfaces at requestor devices to flexibly, accurately, and efficiently generate and fulfill transportation matches between provider devices and proxy rider devices. For example, the proxy matching system can provide an integrated user interface to a requestor device for generating transportation requests for another user (e.g., a proxy rider and corresponding proxy rider device) of a transportation matching system. In response to receiving such a proxy transportation request, the proxy matching system can identify a provider device to provide a transportation service for the rider device and can provide proxy rider identification information through a provider interface at the provider device. By providing digital information regarding the proxy rider to the provider device (and providing information regarding the driver to the rider device), the proxy matching system can provide seamless digital communication between the provider device and the proxy rider device (as if the rider device directly generated the request). Further, the proxy matching system can generate and provide coordinated user interfaces between the requestor device and the provider device. To illustrate, the proxy matching system can provide dynamic notifications, such as real-time GPS location information, to the requestor device and the proxy rider device during the transportation service.

To illustrate, in one or more implementations, the proxy matching system can receive a transportation request from a requestor device (of a requestor) for providing a transportation service (e.g., a ride) to a proxy rider different from the requestor. Based on the transportation request from the requestor device, the proxy matching system can access rider identification information from a rider profile database. Additionally, the proxy matching system can provide the rider identification information and the location of the proxy rider to the provider device, which the provider device displays within a provider user interface. Further, the proxy matching system can provide the provider information and the location of the provider device to the rider device, which is displayed within a rider user interface.

As mentioned above, the proxy matching system can utilize a requestor device to initiate a proxy transportation request. In particular, the proxy matching system can provide a user interface at a requester device that includes selectable elements for identifying proxy riders and other transportation service information. For example, the proxy matching system can access digital contact lists via the requestor device and generate a selectable list of proxy riders for selection by the requestor. The proxy matching system can utilize a reverse-look-up process to verify that contacts are registered with the transportation matching system (or invite contacts to register). In addition, the proxy matching system can provide user interface elements for selecting a proxy pick-up location, drop-off location, pick-up time, and/or vehicle type. Based on selection of a proxy rider, a pick-up location, and/or a destination location at the requestor device, the proxy matching system can initiate a proxy transportation request.

In some implementations, the proxy matching system can automatically surface notifications to a requestor for generating a proxy transportation request. For example, if the proxy matching system detects that a pick-up location for a transportation request is not near the location of the requestor device, then the proxy matching system may cause the requestor user interface to prompt the requestor as to whether the transportation request is a proxy transportation request for another user (e.g., a proxy rider). As described below, the proxy matching system can utilize other approaches for detecting when a transportation request being started at the requestor device is better suited as a proxy transportation request for a user other than the requestor.

Upon receiving a proxy transportation request, the proxy matching system can initiate a transportation service for a rider and corresponding rider device. For example, the proxy matching system can receive an identifier of the rider from the requestor device and conduct a search of a rider profile database to confirm rider identity, verify that the rider is a registered user (or invite the rider to register), and identify proxy rider identifying information. To illustrate, the proxy matching system can receive a telephone number of the rider from the requestor device, and utilize the telephone to identify a profile corresponding to the rider from a profile database. The proxy matching system can then determine rider identification information (e.g., a rider digital image, rider name, and/or rider contact information) for initiating a transportation service.

As mentioned, the proxy matching system can also generate a transportation match between a provider device and the rider device and provide user interfaces to the provider device and the rider device regarding the transportation service. To illustrate, based on the pick-location, drop-off location, and/or transportation time, the proxy matching system can match a provider device to the rider device. Moreover, the proxy matching system can provide rider identification information (e.g. rider name, contact information, or digital image) and transportation service information (e.g., pick-up location and rider device location) to a user interface of the provider device. Similarly, even though the rider device may not initiate the transportation request, the proxy matching system can transmit provider identification information (e.g. provider vehicle type, contact information, or provider name) and additional transportation information (e.g., pick-up location and provider device location) to a user interface of the rider device. Accordingly, the proxy matching system can provide user interfaces that allow the provider device and rider device to directly communicate and coordinate a transportation service.

Moreover, as mentioned above, the proxy matching system can provide coordinated user interface elements and options to the requestor device to facilitate the transportation service. For example, in addition to transmitting provider identification information to the rider device, the proxy matching system can transmit provider identification information to include within a requestor user interface at the requestor device. In addition, in some implementations, the proxy matching system provides real-time status information to both the requestor device via the requestor user interface and the rider device via the rider user interface. To illustrate, even though the requestor may not be a passenger within a transportation vehicle, because the transportation request was generated at the requestor device, the proxy matching system can provide up-to-date ride information to the requestor device with respect to the ride. In particular, the media presentation system can cause the requestor user interface on the requestor device to update with the location of the rider device including when the rider device has reached a destination location. Indeed, in many implementations, the proxy matching system can synchronize the user interfaces at the rider device and the requestor device, as further described below.

Even though the proxy matching system can provide a rider user interface and a requestor user interface with synchronized and/or overlapping information, in some embodiments, the proxy matching system provides different sets of selectable options customized to either the requestor device or the rider device. For example, when a proxy transportation request is created, the proxy matching system can create a requestor information set and a rider information set within a ride object of a ride database. Based on these information sets, the proxy matching system can cause the requestor user interface and the rider user interface to include different sets of selectable transportation options. Thus, for example, the requester user interface at the requestor device can include an option to modify a destination location (even though that option that may not be available via the rider user interface).

As mentioned above, conventional on-demand transportation provider systems suffer from a number of technical drawbacks in relation to flexibility, accuracy, and efficiency of operation. To illustrate, many conventional systems are rigid in that they only allow a requestor device to set up a transportation request for the requestor. Indeed, when attempting to request a ride, these conventional systems require that a requestor set up a transportation request and participate in the transportation service as a passenger. However, this rigidity leads to additional technical problems.

To illustrate, the rigidity of conventional systems often leads requestor devices to provide incorrect digital transportation requests, which causes inaccuracies, delays, cancellations, and wasted computer resources. Specifically, requestor devices utilizing conventional systems often submit inaccurate transportation requests identifying the requestor as the rider, while instructing another person to take their place as a passenger. This approach leads to delays, inefficiencies, and wasted computing resources.

As an initial matter, this approach utilized by conventional systems introduces inefficiencies right from the outset in that provider devices and rider devices are unable to communicate. Indeed, because transportation requests reflect a requestor device, the provider device is forced to communicate through the requestor device, and the requestor device lacks any direct tie to the rider device. Accordingly, conventional systems inefficiently require digital communication through the requestor device in order to align the provider device and the rider device.

Additionally, conventional systems operate inaccurately (which often leads to further inefficiencies). For example, conventional systems often provide digital information regarding the requester device to the provider device, even though the requestor device may not be travelling with the provider vehicle. Indeed, in arranging a pick-up, conventional systems often provide the location of the requestor device to the provider device, even though the requestor device is far away from the agreed-upon pickup locations. This approach often causes confusion and leads to wasted time, additional processing resources, and increased cancellations. Likewise, conventional systems are often unable to provide accurate information regarding the provider and the provider device to a rider as this information is sent instead to the requestor device.

In addition, even if provider devices and requestor devices can align at a pick-up location, provider devices often delay or cancel resulting transportation services leading to additional loss of time and wasted computing resources. Indeed, when a provider arrives at a pickup location expecting to pick up a requestor, providers are instead met with an unidentified stranger (i.e., a person that does not match the requestor). If provider devices do not contain digital information that match to a requestor/requestor device at the pickup location, the provider device cannot verify the identity or trustworthiness of the unknown rider. As a result, provider devices often delay or cancel the transportation service (e.g., empirical data suggest that providers cancel around 13% of transportation requests when the transportation request is for another rider). This necessitates additional digital communication and processing power (e.g., to either verify the identity of the rider or to cancel the transportation request, receive a new transportation request from the rider, identify a new transportation match, align the provider and rider, etc.).

In contrast, the proxy matching system provides several advantages and benefits over conventional on-demand transportation information systems. To illustrate, the proxy matching system improves the flexibility of operations of computing devices by utilizing a requestor device to generate proxy transportation requests for another rider. As detailed further below, the proxy matching system provides tools and transportation options for a requestor device to generate a proxy transportation request for another rider (i.e., a proxy rider) and rider device. Indeed, the proxy matching system provides both frontend (e.g., graphical user interfaces on the requestor device and the rider device) as well as backend (e.g., server-side) modifications to seamlessly facilitate proxy transportation requests.

In addition, the proxy matching system can improve flexibility and efficiency by providing user interfaces at provider devices and rider devices to improve digital communication upon generation of the proxy transportation request at the requestor device. Accordingly, the proxy matching system can more flexibly align provider devices and rider devices at pick-up locations in fulfilling proxy transportation requests. Moreover, the proxy matching system can also improve flexibility at the requestor device. For example, the proxy matching system can send real-time status updates to the requestor device while still allowing the requestor device to flexibly create additional transportation requests (e.g., transportation requests for the requestor or additional proxy transportation requests for other riders). Thus, the proxy matching system can flexibly manage multiple transportation requests originating from a single requestor device.

Further, the proxy matching system provides increased accuracy. As mentioned above, the proxy matching system can provide accurate rider identification information and provider identification information across the provider device, requestor device, and rider device. Indeed, the proxy matching system can provide verified rider identification information (e.g., the rider's registered name, contact information, and image) to the provider device in addition to the location of the rider device. Moreover, the proxy matching system can provide the rider device with accurate provider identification information and the location of the provider device.

These improvements can also lead to advancements in efficiency by reducing the time and computing resources required to perform iterative or repetitive processes that plague conventional systems. For example, by providing accurate information via user interfaces of the provider device and the requestor device, the proxy matching system can reduce delays, cancelations, and wasted resources in aligning devices at pick-up locations. Moreover, the proxy matching system can reduce digital communications and computational resources by coordinating directly between the provider device and the rider device without the requestor device serving as an intermediary. Furthermore, the proxy matching system reduces the number of acts needed to fulfill a proxy transportation request by directly incorporating rider devices into the transportation service.

Moreover, the proxy matching system can provide multiple customized graphical user interfaces that can reduce time and interactions for requestors, providers, and riders. For example, the proxy matching system can provide a requestor user interface that automatically guides a requestor to initiate, generate, and submit a proxy transportation request. Indeed, the proxy matching system can generate a user interface that reduces the number of interactions and acts needed to generate a proxy transportation request on a requestor device. Likewise, the proxy matching system can generate a rider user interface that seamlessly guides a rider through a transportation service. Indeed, the rider user interface provides the rider device with a proxy transportation request that is automatically generated for the rider. Further, the rider user interface launches actions automatically for the rider, enabling the rider to receive a ride with minimal or no interactions at the rider device.

As indicated by the foregoing discussion, the present disclosure utilizes a variety of terms to describe features and advantages of the proxy matching system. For example, as used herein, the term “transportation provider” (or simply “provider”) refers to a driver (or autonomous operator) that operates a transportation vehicle. For instance, a transportation provider includes a person that drives a transportation vehicle—or an autonomous vehicle—that provides transportation services to pick up and drop off passengers.

Relatedly, the term “provider device” refers to a computing device associated with (or used by) a provider or a transportation vehicle. For example, a provider device can include a mobile device of a human operator or a computing device of an autonomous vehicle. In some embodiments, a provider device includes a provider application comprising instructions that (upon execution) cause the provider device to perform various actions for a transportation matching system, as described herein. Such instructions may likewise cause a provider device to present a graphical user interface (e.g., a provider user interface) that includes rider identification information, user ratings, transportation routes, and/or user locations.

As suggested above, the term “requestor” refers to an individual that submits a transportation request to a transportation matching system. For instance, a requestor includes a person who interacts with a requestor device to send a transportation request to a transportation matching system. A requestor can submit a transportation request for himself or herself or can submit a proxy transportation request for a proxy rider via a requestor device.

Relatedly, the term “requestor device” refers to a computing device associated with (or used by) a requestor. In some embodiments, a requestor device includes a requestor application comprising instructions that (upon execution) cause the requestor device to perform various actions for a transportation matching system, as described herein. Such instructions may likewise cause a requestor device to present a graphical user interface (e.g., a requestor user interface) that includes provider information, provider locations, transportation routes, and/or other transportation-related information. In some implementations, the requestor user interface includes a requestor-based set of transportation options with respect to a transportation service for a proxy rider.

As used herein, the term “proxy rider” refers to an individual that participates in a transportation service (e.g., ride) initiated by a requestor or requestor device. For instance, a proxy rider includes a passenger of a transportation service, where the proxy rider is different than the requestor. A proxy rider may refer to an individual for whom a requestor has initiated a transportation request, where the individual is still waiting for pick-up from a provider. A proxy rider can also refer to an individual who is currently riding within a transportation vehicle to a destination as part of a ride initiated by a requestor.

Relatedly, the term “rider device” refers to a computing device associated with (or used by) a rider. In some embodiments, a rider device includes a rider application comprising instructions that (upon execution) cause the rider device to perform various actions for a transportation matching system, as described herein. Such instructions may likewise cause a rider device to present a graphical user interface (e.g., a rider user interface) that includes provider information, provider locations, transportation routes, and/or other transportation-related information. In some implementations, the rider user interface includes a rider-based set of transportation options during a transportation service.

As used herein, the term “transportation request” (or simply “request”) refers to a digital application, invitation, or request for transportation services. A transportation request can include a collection of data sent to a transportation matching system comprising information associated with a transportation service sought by a requestor (e.g., pick-up location, drop-off location, transportation mode). In response to a transportation request, the transportation matching system can match the request to at least one provider (e.g., a transportation provider) to fulfill the request. Relatedly, the term “proxy transportation request” (or simply “proxy request”) refers to a transportation request for a proxy rider. For example, a requestor at a requestor device can submit a proxy transportation request for a proxy rider that is different than the requestor.

As used herein, the term “identification information” refers to information associated with an individual, entity, or user of the transportation matching system. In many instances, the transportation matching system may store user identification information (e.g., requestor information, rider identification information, and provider information) in a user profile database (e.g., a rider profile database) and/or a provider profile database. In addition, rider identification information can include a system user identifier for the rider, personal information (e.g., full name, address, date of birth, etc.), contact information (e.g., mobile number, email address, etc.), rider device information (e.g., device identifier, current and stored location), user rating, preferences (e.g., vehicle type, provider, music, etc.), images, reviews, and other information associated with the user. As another example, provider identification information can include vehicle information (e.g., make, model, color, year, licensee plate, etc.), personal information, contact information, provider device information (e.g., device identifier, current and stored location), provider rating, reviews, images, and other stored provided information.

Additional detail will now be provided regarding one or more embodiments of the proxy matching system in relation to illustrate figures. While the following figures provide illustrations and accompanying description with respect to driver-operated vehicles, the figures apply to other types of transportation vehicles as well as driverless or autonomous vehicles.

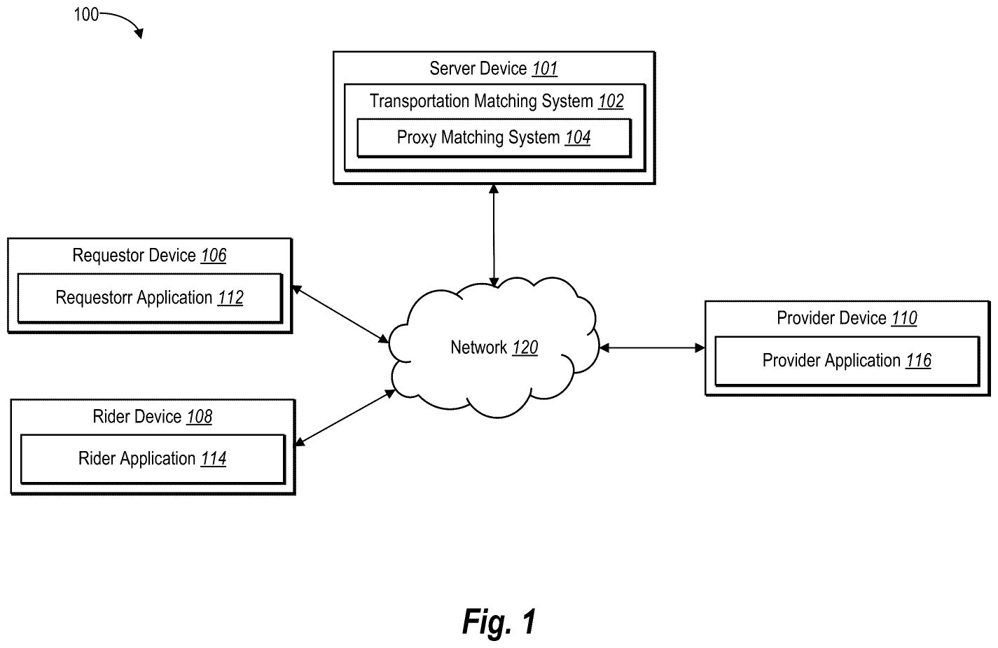

For example, FIG. 1 illustrates a block diagram of a system environment 100 (or “system 100”) for implementing a proxy matching system 104 in accordance with one or more embodiments. As shown, the system 100 includes a server device 101 hosting the proxy matching system 104 as part of a transportation matching system 102. The system 100 further includes a requestor device 106, a rider device 108, and a provider device 110, which can communicate with the proxy matching system 104/transportation matching system 102 via a network 120.

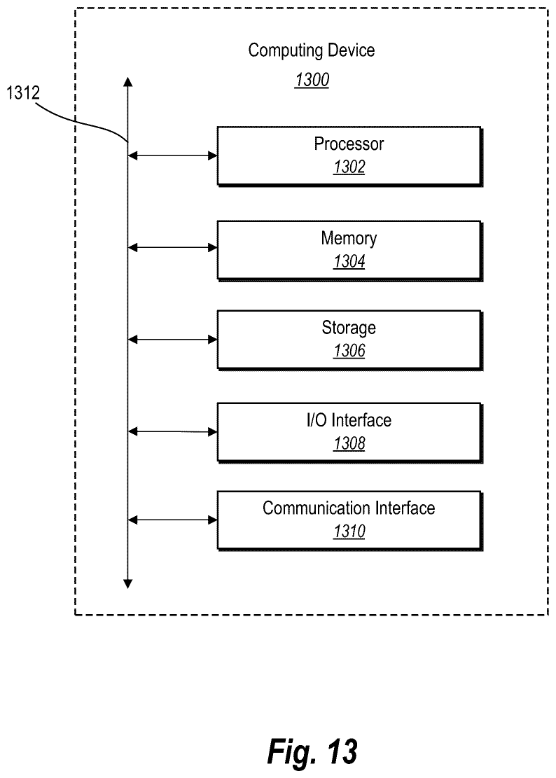

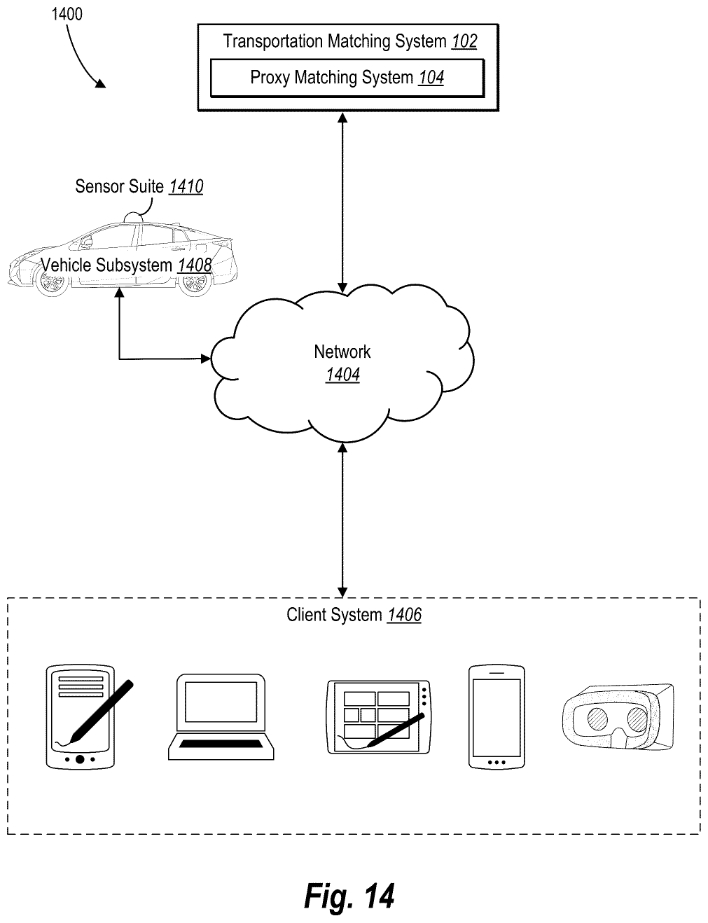

The server device 101 can include one or more computing devices to implement the transportation matching system 102 and/or the proxy matching system 104. Further, a client device can represent each of the requestor device 106, the rider device 108, and the provider device 110. Indeed, the requestor device 106, the rider device 108, and the provider device 110 can comprise any computing device as described in FIGS. 13-14. Additional description regarding the illustrated devices (101, 106, 108, and 110), as well as the network 120, is provided with respect to FIGS. 13-14 below.

As shown, the proxy matching system 104 utilizes the network 120 to communicate with the requestor device 106, the rider device 108, and the provider device 110. For example, the proxy matching system 104 receives a proxy transportation request from the requestor device 106 for a rider associated with the rider device 108. In response, the proxy matching system matches the rider device 108 with the provider device 110.

Further, the proxy matching system 104 and/or the transportation matching system 102 can track and communicate a status of the provider device 110 to provide an indicator for a location of the provider device 110 for display on the requestor device 106 as well as the rider device 108 as a vehicle icon within a graphical map. In some embodiments, per device settings, the proxy matching system 104 receives device information from the requestor device 106, the rider device 108, and the provider device 110 such as location coordinates (e.g., latitude, longitude, and/or elevation from a global positioning system (GPS)) and status (currently riding, not riding, available, or unavailable) for matching requests.

As indicated by FIG. 1, the requestor device 106 includes a requestor application 112, the rider device 108 includes a rider application 114 and the provider device 110 includes a provider application 116. Each of the applications (i.e., the requestor application 112, the rider application 114, and the provider application 116) can optionally include computer-executable instructions that, when executed by the corresponding device (e.g., the requestor device 106, the rider device 108, and the provider device 110), cause the corresponding device to perform certain functions as described herein.

To illustrate, to facilitate connecting requests with transportation vehicles (e.g., vehicles associated with provider devices), the proxy matching system 104 communicates with the requestor device 106 (e.g., through the requestor application 112), the rider device 108 (e.g., through the rider application 114), and the provider device 110 (e.g., through the provider application 116). For example, the proxy matching system 104 receives and provides information including transportation request information (e.g., pick-up locations and/or drop-off locations) and provider device information (e.g., provider device locations) to the requestor device 106 via the requestor application 112 and/or the rider device 108 via the rider application 114.

While the requestor application 112 and the rider application 114 are shown as separate applications, in various implementations, the requestor application 112 and the rider application 114 can be the same application. For example, both applications are based on the same coding and instruction framework provided by the proxy matching system 104 and/or transportation matching system 102. In these implementations, however, some aspects of the requestor application 112 may appear different from the rider application 114 as the different roles (e.g., requestor and rider) cause the applications to display different user interface elements at different stages of the application. In alternative implementations, the requestor application 112 differs from the rider application 114. For example, the requestor application 112 enables submitting proxy transportation requests while the rider application 114 only allows non-proxy transportation requests.

Additionally, the provider application 116 can differ from both the requestor application 112 and the rider application 114. For example, the provider application 116 can include multiple transportation matching modes (e.g., a destination transportation matching mode) that each corresponds to different algorithms or rule sets for matching transportation requests with the provider device 110. Indeed, the provider application 116 can enable a provider device 110 to accept transportation requests and proxy transportation requests as well as provide transportation services (e.g., rides) to riders.

As indicated above, the proxy matching system 104 can provide (or cause the provider device 110 to render) visual indicators for locations associated with transportation requests (including proxy transportation requests). For example, in some cases, the proxy matching system 104 selects the provider device 110 to service a transportation request received from the requestor device 106 based on various factors such as a location associated with the transportation request (e.g., a pickup location), a provider device location, locations of other provider devices, a directional filter, an arrival time filter, provider incentives, requestor incentives, a time of day, traffic information, and/or other transportation matching considerations. Based on selecting the provider device 110 to service the proxy transportation request, the proxy matching system 104 provides a visual indicator for the transportation request for display within a user interface displayed on the provider device 110 (e.g., as part of the provider application 116).

Although FIG. 1 illustrates the system 100 having a particular number and arrangement of components associated with the proxy matching system 104, in some embodiments, the system 100 may include more or fewer components with varying configurations. For example, the proxy matching system can be implemented on a server device apart from the transportation matching system 102. In some embodiments, the proxy matching system 104 can communicate directly with the provider device 110, bypassing the network 120. Moreover, the proxy matching system 104 can be implemented (entirely or in part) on the provider device 110. Additionally, the proxy matching system 104 can include or communicate with a database for storing transportation request information, arrival time information, and/or other information described herein.

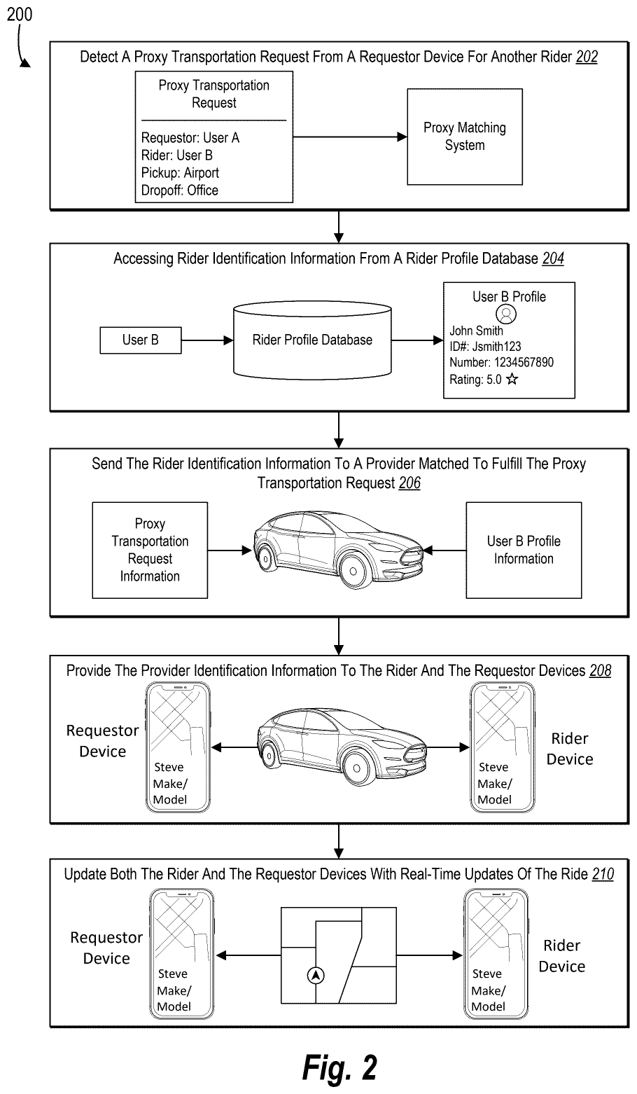

As mentioned, the proxy matching system 104 can facilitate the generation and fulfillment of proxy transportation requests. To illustrate, FIG. 2 shows an overview of the proxy matching system 104 generating and fulfilling a proxy transportation request submitted by a requestor device for a proxy rider in accordance with one or more embodiments. In particular, FIG. 2 shows a flow diagram of a series of acts 200. In one or more implementations, the proxy matching system 104 implements the series of acts 200 shown in FIG. 2. In alternative implementations, the transportation matching system 102 can implement one or more acts in the series of acts 200.

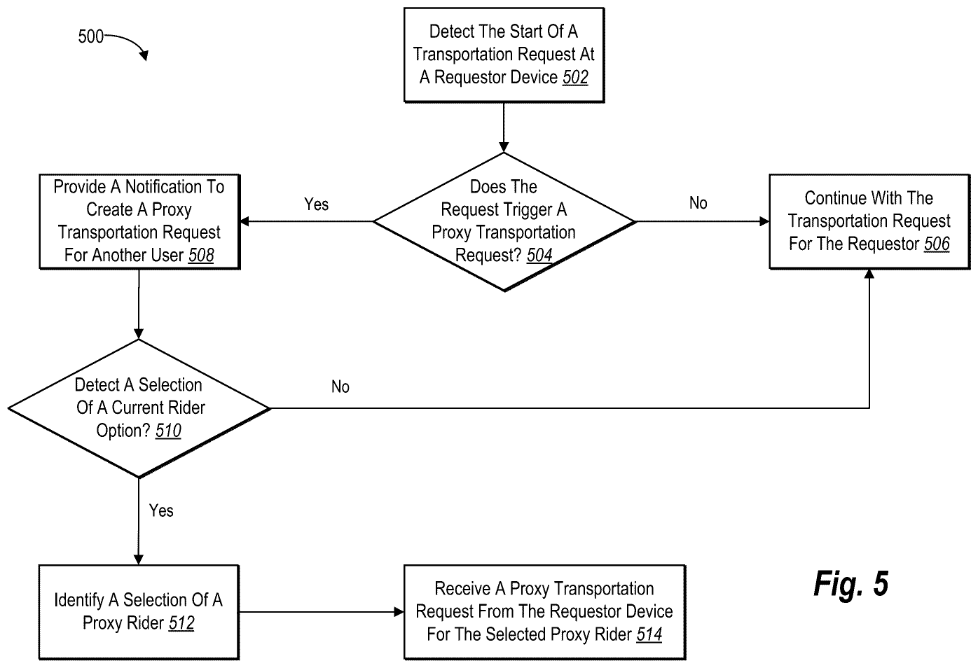

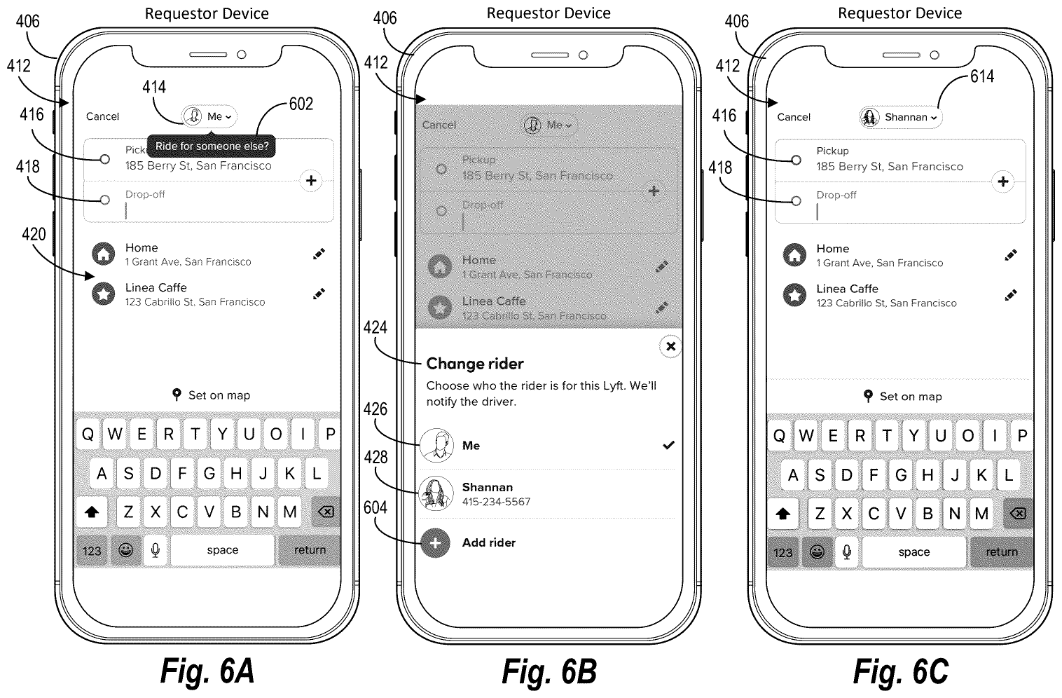

As shown, the series of acts includes an act 202 of the proxy matching system 104 detecting a proxy transportation request from a requestor device for another rider (e.g., a proxy rider). For example, the proxy matching system 104 can determine that a requestor is starting a transportation request for another rider. In response, the proxy matching system 104 can prompt the user to select a proxy rider as well as submit a proxy transportation request for the proxy rider. Additional detail regarding detecting a proxy transportation request is provided below with respect to FIGS. 5-6D.

To illustrate, the act 202 shows a proxy transportation request where the requestor (“User A”) has generated the proxy transportation request for a proxy rider (“User B”). For example, User A utilizes their requestor device to generate the proxy transportation request for the proxy rider. In addition, the proxy transportation request includes a pickup and dropoff location. The proxy matching system 104 can receive the proxy transportation request, as illustrated.

As shown, the series of acts includes an act 204 of the proxy matching system 104 accessing rider identification information from a rider profile database. For example, the proxy matching system 104 can utilize information from the proxy transportation request and/or from the requestor device to identify a registered rider (e.g., a known user) of the transportation matching system 102. To illustrate, the proxy matching system 104 matches the proxy rider name from the requestor device to the registered rider “John Smith” in the rider profile database. Further, upon accessing the proxy rider in the rider profile database, the proxy matching system 104 can gather other information about the proxy rider, such as their user identifier, number, rating, etc.

Additionally, as shown, the series of acts includes an act 206 of the proxy matching system 104 sending the rider identification information to a provider matched to fulfill the proxy transportation request. For instance, the proxy matching system 104 utilizes information in the proxy transportation request to match a provider device to the proxy rider. Further, the proxy matching system 104 can provide the rider identification information to the provider device. In many implementations, the proxy matching system 104 provides the rider identification information to the provider device in a manner that appears as if the rider directly submitted the transportation request themselves.

Further, as shown, the series of acts includes an act 208 of the proxy matching system 104 providing the provider identification information to the rider device and the requestor device. In particular, upon matching the proxy transportation request for the proxy rider to a provider device, the proxy matching system 104 can cause the rider user interface on the rider device and the requestor user interface on the requestor device to display provider identification information, such as the location of the provider device, estimated pickup time, vehicle information, and provider rating. Indeed, even though the proxy transportation request originated from the requestor device separate from the rider device, the proxy matching system 104 can provide the proxy transportation request, including the provider identification information, to the rider device.

As shown, the series of acts includes an act 210 of the proxy matching system 104 updating both the rider device and the requestor device with real-time updates of the ride. For example, the proxy matching system 104 can cause the rider user interface on the rider device and the requestor user interface on the requestor device to display status updates, such as the current location of the provider device while the rider is waiting for pick up as well as the location of the rider during the scheduled ride. For example, the proxy matching system 104 provides real-time map updates of the ride to the rider device and the requestor device. Additionally, the proxy matching system 104 can indicate to the rider device and the requestor device when the ride has been completed.

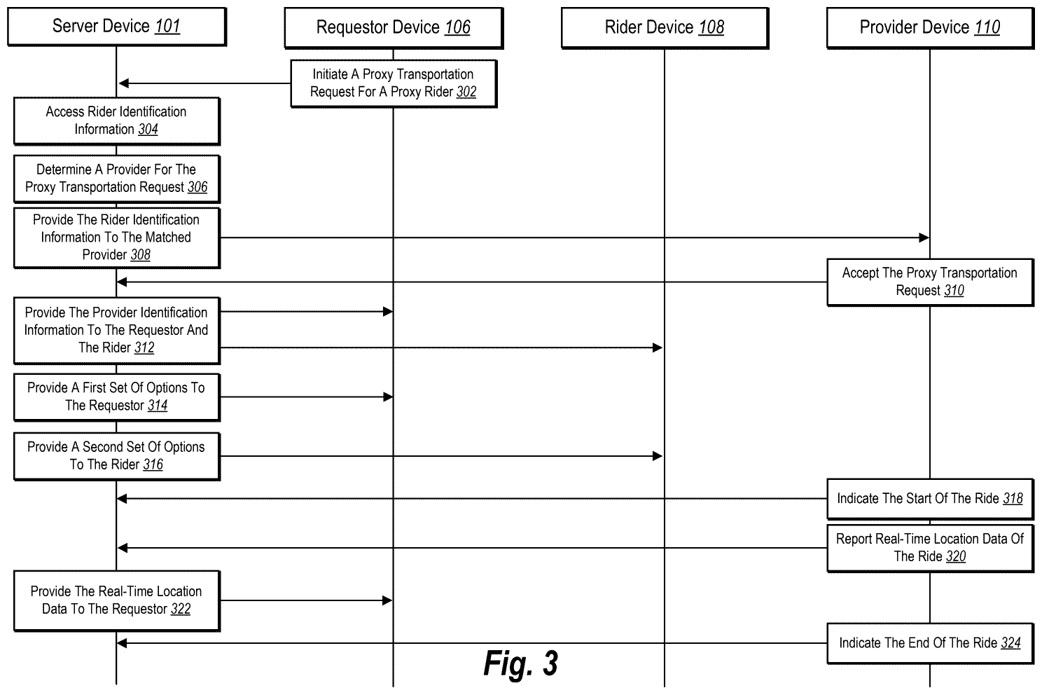

As just described, the proxy matching system can generate and fulfill a proxy transportation request utilizing a server device, requester device, provider device, and rider device. FIG. 3 shows a sequence flow diagram of multiple devices communicating to complete a proxy transportation request submitted at a requestor device for a proxy rider in accordance with one or more embodiments. As shown, FIG. 3 includes a series of acts performed by the proxy matching system 104 via the server device 101, requestor device 106, the rider device 108, and the provider device 110, which are in communication with each other. Indeed, the proxy matching system can be implemented on one or more of the server device 101, requestor device 106, the rider device 108 to perform the series of acts shown in FIG. 3.

As shown, the series of acts includes an act 302 of the requestor device 106 initiating a proxy transportation request for a proxy rider. For instance, the requestor device 106 detects input from a requestor to start a transportation request. Further, the requestor device 106 detects that the transportation request is a proxy transportation request for a proxy rider. For example, the requestor device 106 detects user input selecting a proxy rider from a list of proxy riders.

More particularly, in some implementations, based on the input of the requestor, the proxy matching system 104 determines that the transportation request is intended for a user other than the requestor (i.e., a proxy rider). In these implementations, the requestor device 106 and/or the proxy matching system 104 can provide a message (e.g., a popup or push notification) on the requestor device 106 indicating an option to generate a proxy transportation request for a proxy rider, as further described below.

As shown, the series of acts includes an act 304 of the server device 101 accessing rider identification information. For example, the server device 101 utilizes contact information on the requestor device 106 within the proxy transportation request to identify a user (i.e., a registered rider) of the proxy matching system 104 (and/or transportation matching system 102). In some implementations, the proxy matching system 104 accesses a rider profile database to access the rider identification information (e.g., rider information).

In one or more implementations, the proxy matching system 104 utilizes a user identifier included in the proxy transportation request to locate the rider in the rider profile database. For example, the proxy transportation request includes a telephone number, an email address, a username, or another user identifier to look up the rider in the rider profile database. Upon accessing the profile of the rider, the proxy matching system 104 can identify other information with respect to the rider, as further described below.

As shown, the series of acts includes an act 306 of the server device 101 determining a provider for the proxy transportation request. In one or more implementations, the proxy matching system 104 (and/or the transportation matching system 102) can utilize information in the proxy transportation request, such as the pickup location or the location of the rider device 108, to match the rider device 108 to a provider device from nearby provider devices. For example, the proxy matching system 104 can utilize a number of metrics and algorithms to match a provider device to the rider device 108, as described above with respect to FIG. 1.

As part of determining a matching proxy rider, the server device 101 can send the rider identification information to a provider device. For example, as shown, the series of acts includes an act 308 of the server device 101 providing the rider identification information to the provider device 110. For instance, the proxy matching system 104 provides the name and rating of the proxy rider to the provider device 110 in connection with details of the transportation request. Based on the transportation request and the rider identification information, the provider at provider device 110 can accept or reject a transportation request.

To illustrate, the series of acts includes an act 310 of the provider device 110 accepting the proxy transportation request. In many implementations, the proxy matching system 104 does not differentiate between a transportation request and a proxy transportation request to the provider device 110. Indeed, because the proxy rider is a registered rider (e.g., a known user) of the transportation matching system 102, the proxy matching system 104 offers the transportation request to the provider device 110 as if the proxy rider submitted the request himself or herself.

As shown, the series of acts includes an act 312 of the server device 101 providing the provider identification information to the requestor device 106 and the rider device 108. In particular, the server device 101 can provide details with respect to the provider (e.g., name, rating, vehicle information, provider device location, estimated pickup time, etc.) to both the requestor device 106 and the rider device 108. Indeed, as the requestor device 106 submitted the proxy transportation request, the server device 101 provides the ride information (including provider identification information) to the requestor device 106. Further, as the transportation service (e.g., the ride) is for the rider, the server device 101 provides the same or similar ride information to the rider device 108, as shown in connection with the act 312.

In various implementations, the act 312 can include the server device 101 sending a message to the requestor device 106 indicating that details of the proxy transportation request and/or the provider identification information has been sent to the rider device 108. For example, the proxy matching system 104 sends a pop-up notification, a push notification, an in-app message, a text message, or an email to the requestor device 106 with such notification.

Similarly, in one or more implementations, the server device 101 can provide a message to the rider device 108 indicating the proxy transportation request and/or the provider identification information. For example, the proxy matching system 104 sends a push notification to the rider device 108 that a ride has been confirmed for the rider. In some implementations, interacting with the notification automatically navigates the rider device 108 to a rider user interface that includes details of the proxy transportation request and/or the provider identification information. Indeed, within a rider application on the rider device 108, the proxy matching system 104 can cause the rider application to display a user interface that includes a notification that the rider has been matched to the provider device 110 in connection with a ride confirmed for the rider (e.g., the user of the rider device 108).

As shown in FIG. 3, the series of acts includes an act 314 of the server device 101 providing a first set of options to the requestor (i.e., the requestor device 106). For example, upon the proxy matching system 104 receiving the proxy transportation request from the requestor device 106, the proxy matching system 104 can provide a requestor or first set of transportation options to the requestor device 106 within a requestor user interface. For example, options allow the requestor device 106 to cancel or modify the proxy transportation request.

In some implementations, the proxy matching system 104, via the requestor device 106, applies a filtering scheme to determine which options from a full set of transportation options to display within the requestor user interface of the requestor device 106. For example, the server device 101 provides instructions to the requestor device 106 to select a filtered set of options that correspond to a requestor submitting a proxy transportation request.

Similarly, the series of acts includes an act 316 of the server device 101 providing a second set of options to the rider (e.g., the rider device 108). In many implementations, the second set of options provided to the rider device 108 differ from the first set of options provided to the requestor device 106. For example, the second set of selectable transportation options enables a rider to cancel a pending transportation service (e.g., ride) or indicate a more specific pickup location; however, they do not enable the rider to change the dropoff location or add stops along the route.

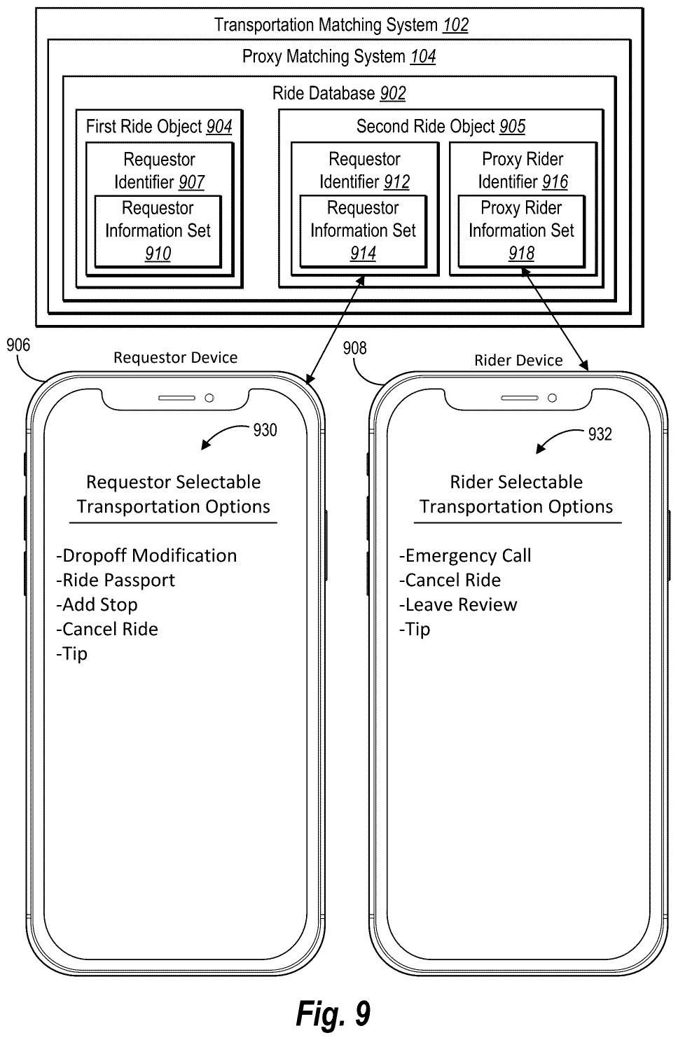

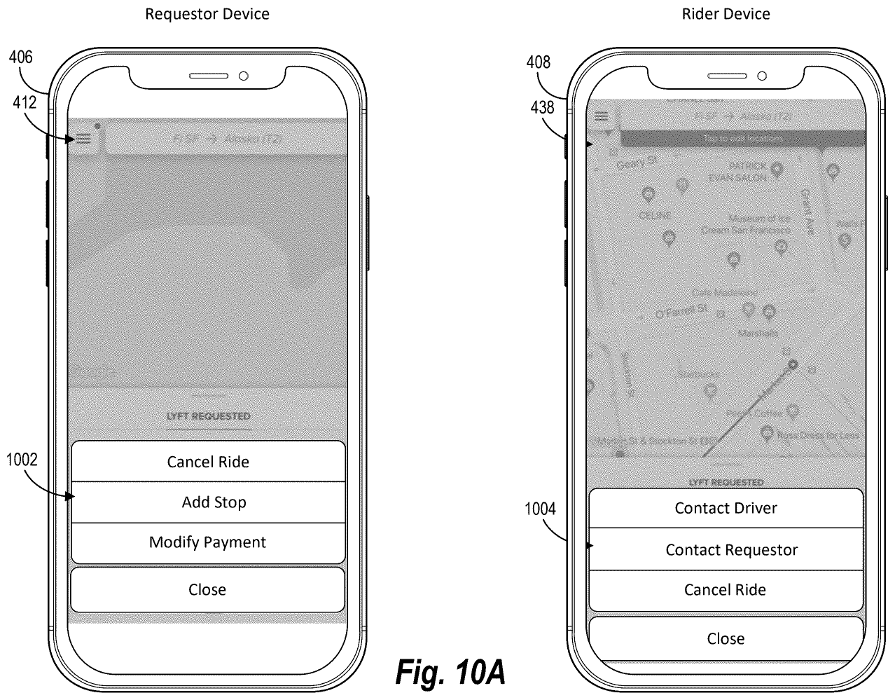

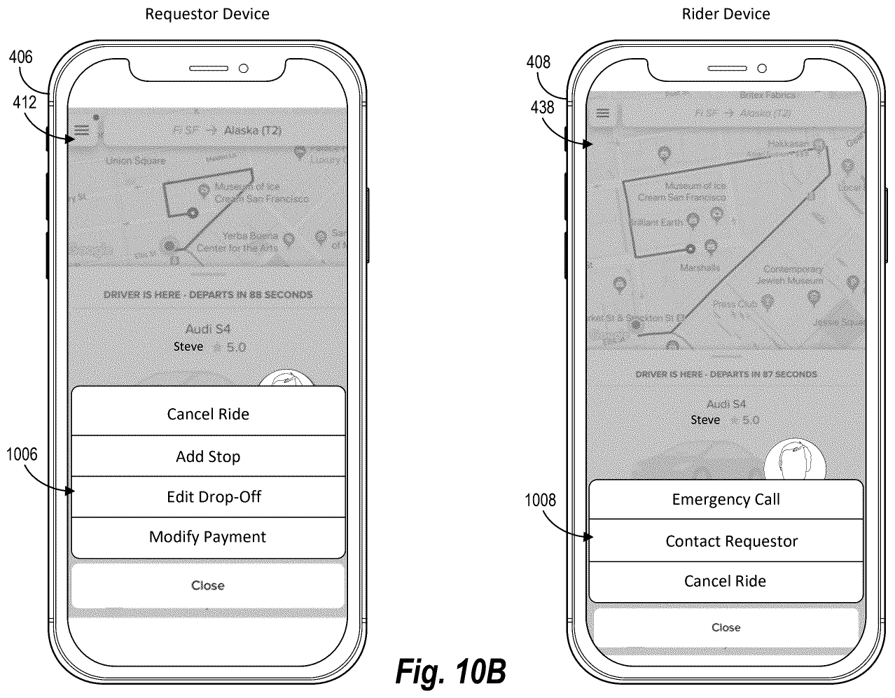

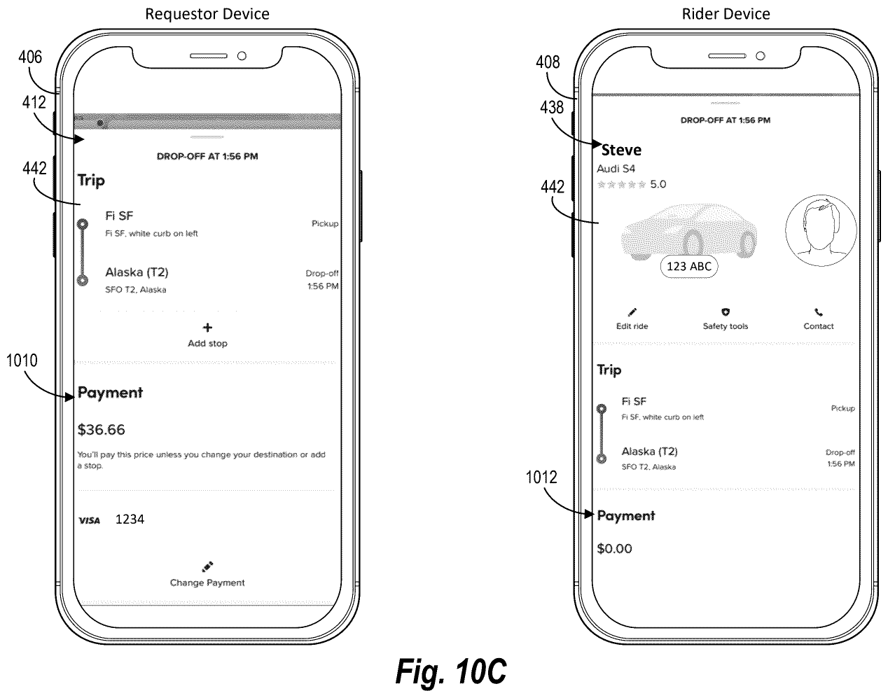

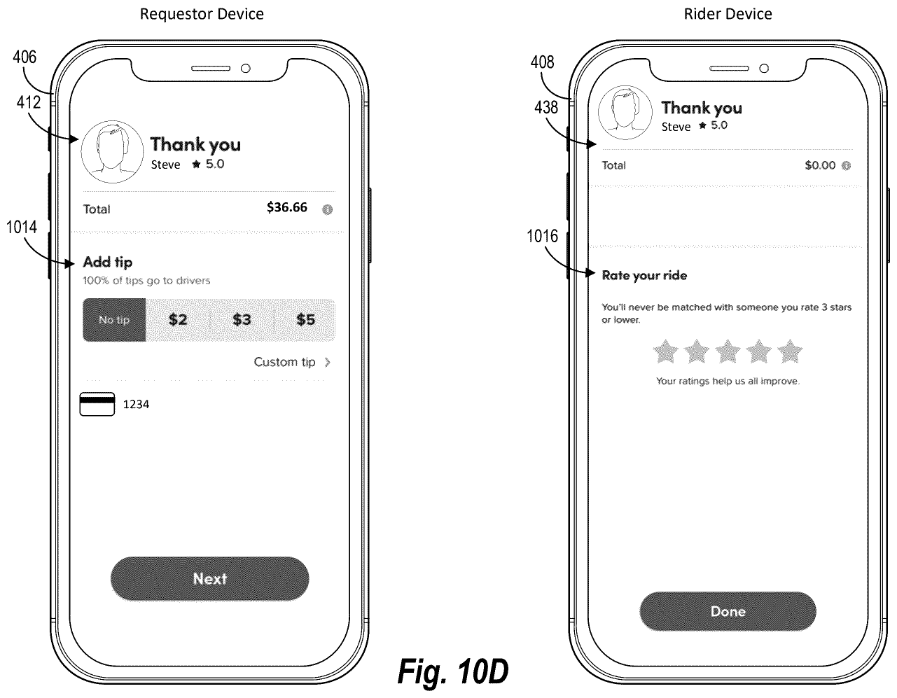

Moreover, in various implementations, the proxy matching system 104 can update the first and second set of selectable transportation options depending on the current status of the ride. For example, the second set of selectable transportation options provided to the rider device 108 can update upon the rider being picked up, then update again upon being dropped off. Examples of various selectable transportation options are provided below in connection with FIGS. 9-10D.

As shown in FIG. 3, the series of acts includes an act 318 of the proxy matching system 104, via the provider device 110, indicating the start of the ride (i.e., the transportation service). For example, upon the provider picking up the rider, the provider device 110 can receive input from the provider confirming the pickup. In response, the provider device 110 can update to display navigational directions to the dropoff location. Further, the provider device 110 can provide a pickup indication to the server device 101 that the ride is starting.

In addition, as shown, the series of acts includes an act 320 of the proxy matching system 104, via the provider device 110, reporting real-time location data of the ride to the server device 101. For example, for the duration of the ride, the provider device 110 sends real-time location data to the server device 101. In some implementations, the rider device 108 can provide real-time location data to the server device 101. Further, in one or more implementations, another device in the vehicle or the vehicle itself (e.g., a vehicle subsystem) can provide the real-time location data to the server device 101.

As shown, the series of acts includes an act 322 of the server device 101 providing the real-time location data to the requestor device 106. For example, the proxy matching system 104, via the server device 101, can provide the location of the rider device 108 and/or the provider device 110 to the requestor device 106, as the requestor is not participating in the ride. In this manner, the proxy matching system 104 can inform the requestor as to when the ride starts, where the rider is during the ride, and when the rider reaches the destination.

As also shown, the series of acts can include an act 324 of the provider device 110 indicating the end of the ride to the server device 101. For instance, the provider device 110 receives input from the provider indicating that the rider has been delivered to the dropoff location, which is provided to the server device 101. In response, the proxy matching system 104, via the server device 101, can provide indications to the requestor device 106 and the rider device 108 indicating the end of the ride. As mentioned above, the requestor device 106 and the rider device 108 can each display updated transportation selectable options within their corresponding user interfaces based on the rider reaching the dropoff location.

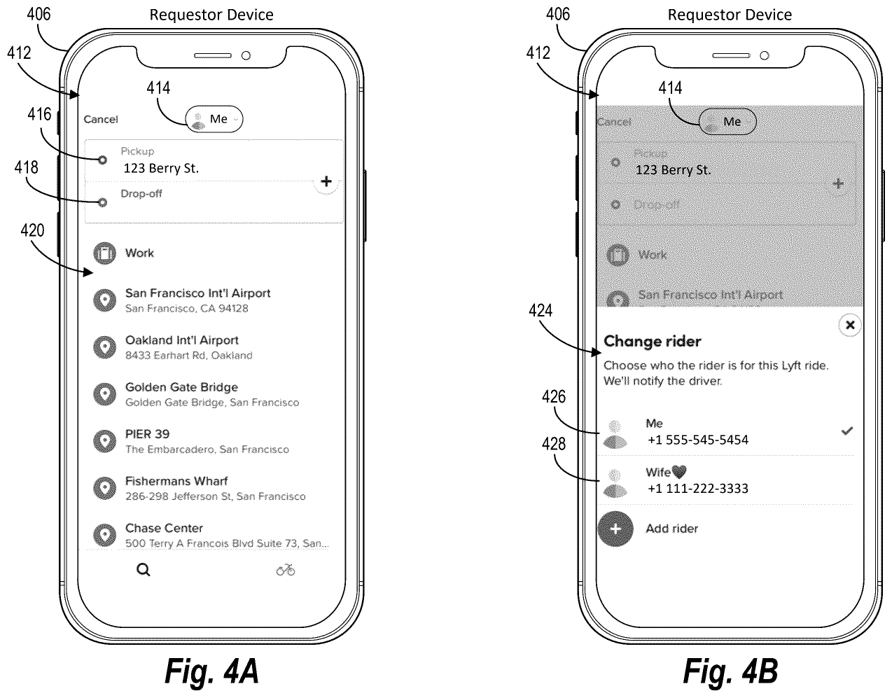

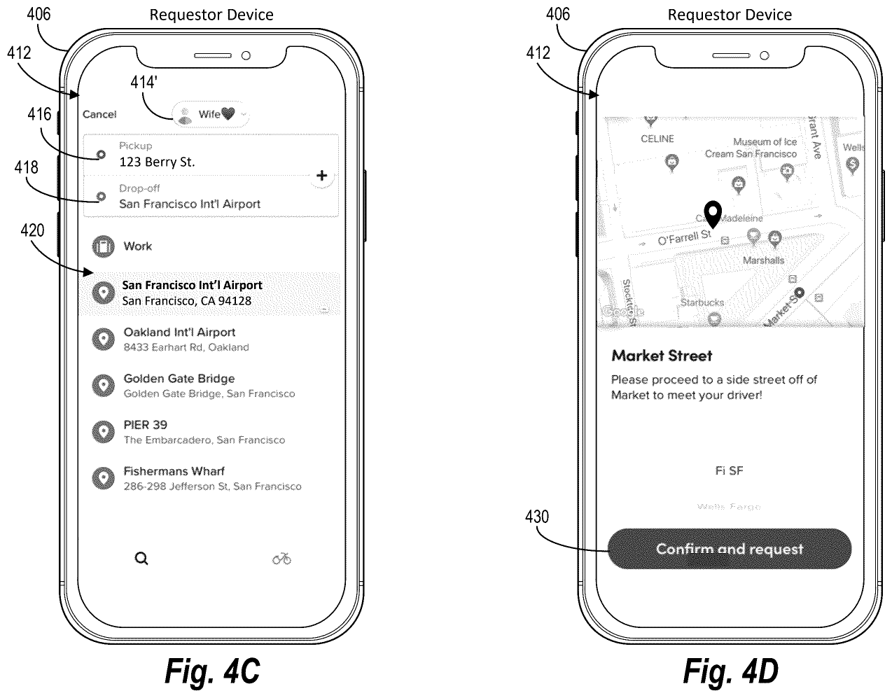

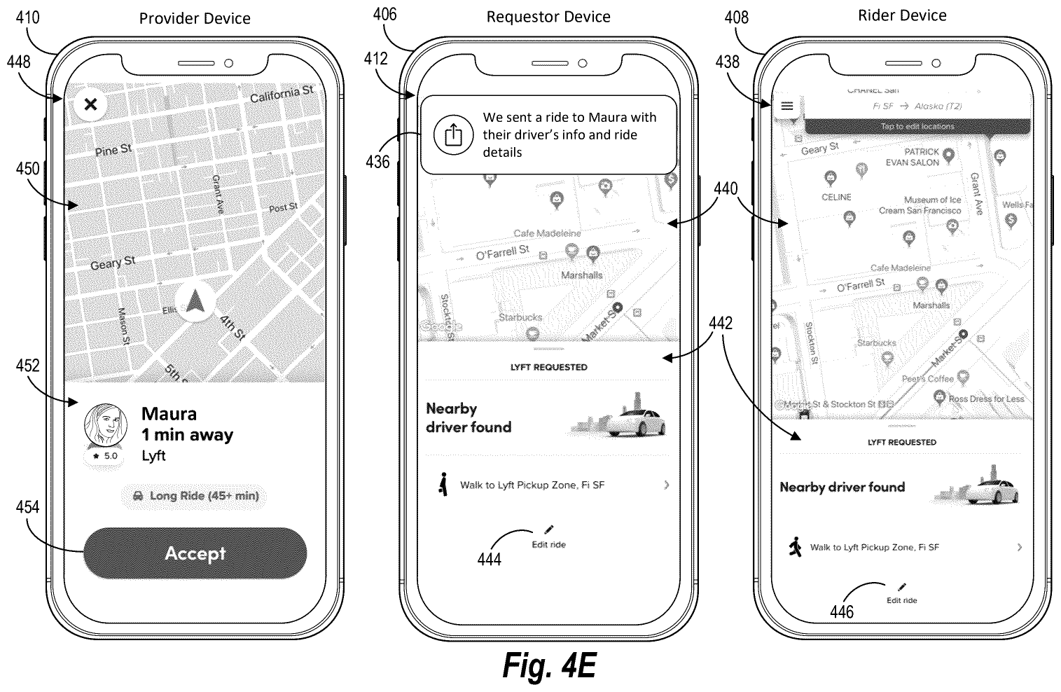

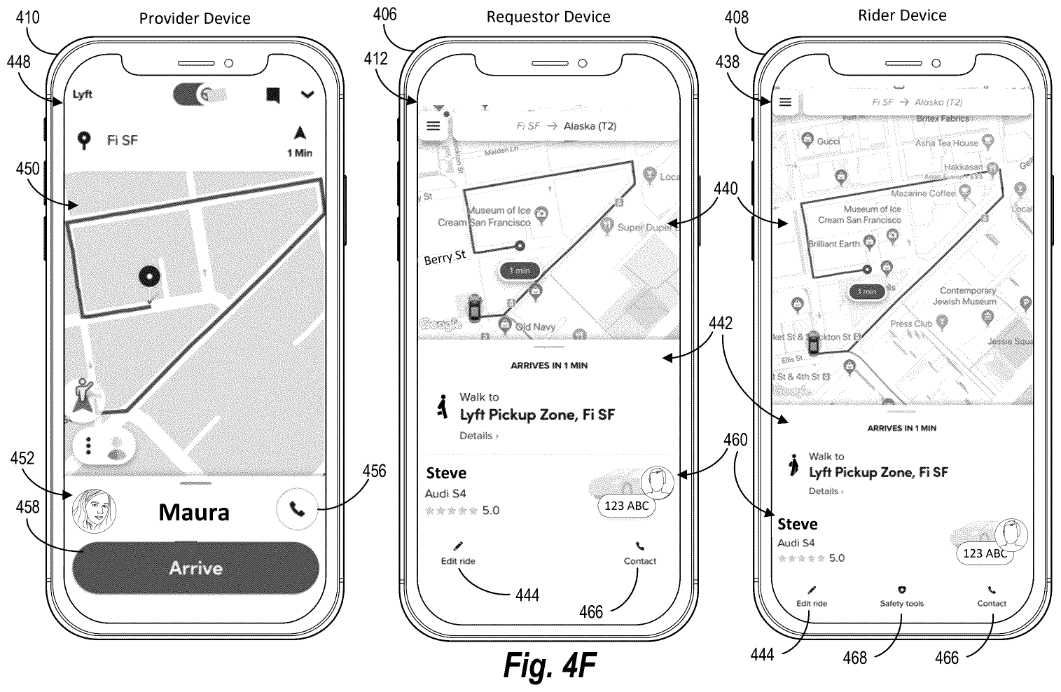

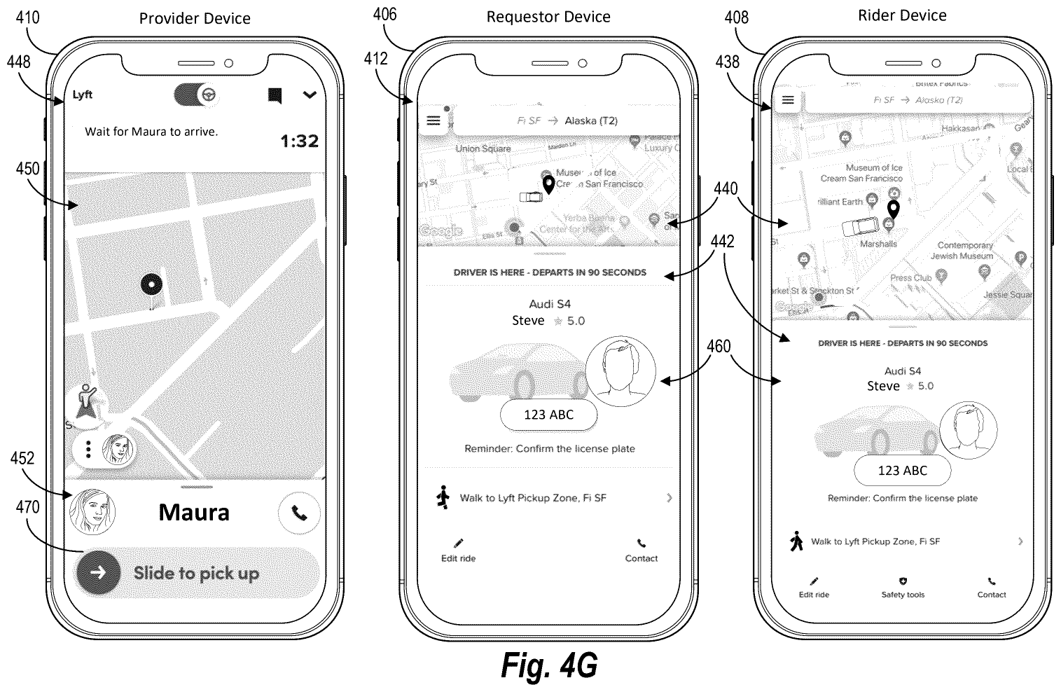

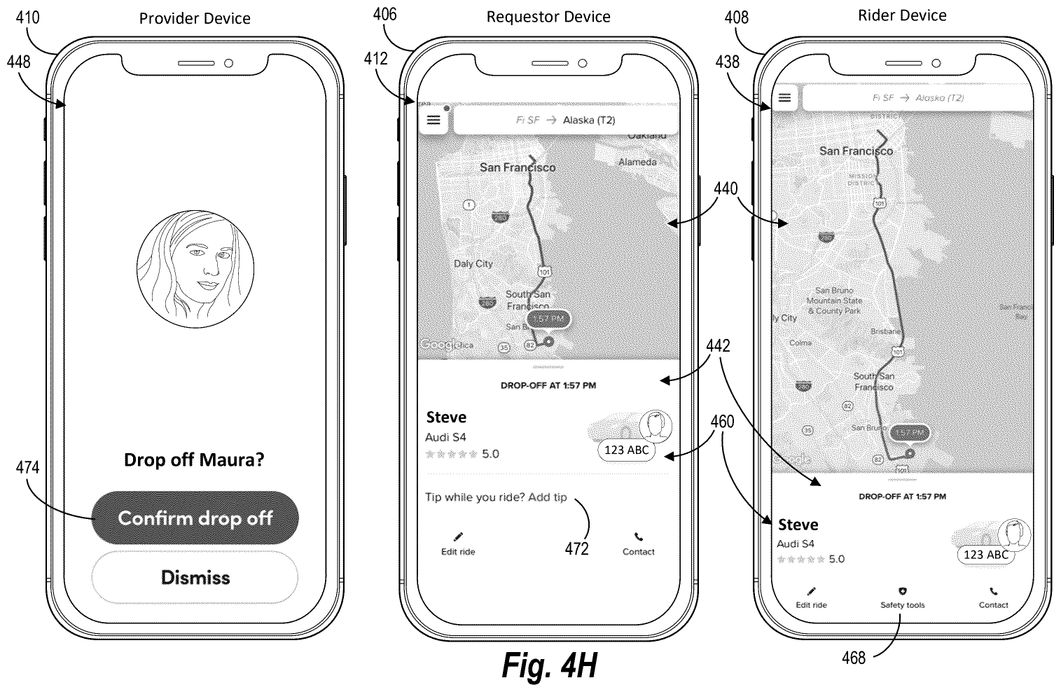

To further illustrate the series of acts described with respect to FIG. 3, FIGS. 4A-4H includes a set of corresponding graphical user interfaces. In particular, FIGS. 4A-4H show graphical user interfaces of a requestor device, a rider device, and a provider device with respect to generating transportation requests submitted by a requestor for a proxy rider in accordance with one or more embodiments.

As shown, FIGS. 4A-4H include a requestor device 406, a rider device 408, and a provider device 410 (e.g., the requestor device 106, the rider device 108, and the provider device 110 described previously). FIGS. 4A-4H show how the proxy matching system 104 (and/or the transportation matching system 102) can cause the graphical user interfaces on the requestor device 406, the rider device 408, and the provider device 410 to update over time based on user input detected as one or more of the devices.

More specifically, FIG. 4A includes the requestor device 406 having a requestor user interface 412 that includes elements, features, graphics, and options for generating a transportation request. For example, the requestor user interface 412 includes text input fields for the pickup location 416 and the dropoff location 418 as well as a list of potential dropoff locations 420 (e.g., popular or previously selected dropoff locations). In addition, the requestor user interface 412 includes a current rider option 414, which indicates the user for whom the transportation request is being generated. As shown, the current rider option 414 indicates that the requestor (i.e., “Me”) is selected as the current rider for the pending transportation request.

As mentioned above, the requestor device 406 can generate a proxy transportation request. For example, the requestor device 406 submits a transportation request for a proxy rider rather than for the requestor himself or herself. To illustrate, in one or more implementations, the requestor can interact with the current rider option 414 to select a proxy rider. For example, in response to selecting the current rider option 414, the requestor device 406 can update to show the requestor user interface 412 included in FIG. 4B. In some implementations, as described below, the proxy matching system 104 can detect that the transportation request is likely for a proxy rider. In response, the proxy matching system 104 can cause the requestor device 406 to prompt the requestor to select a proxy rider.

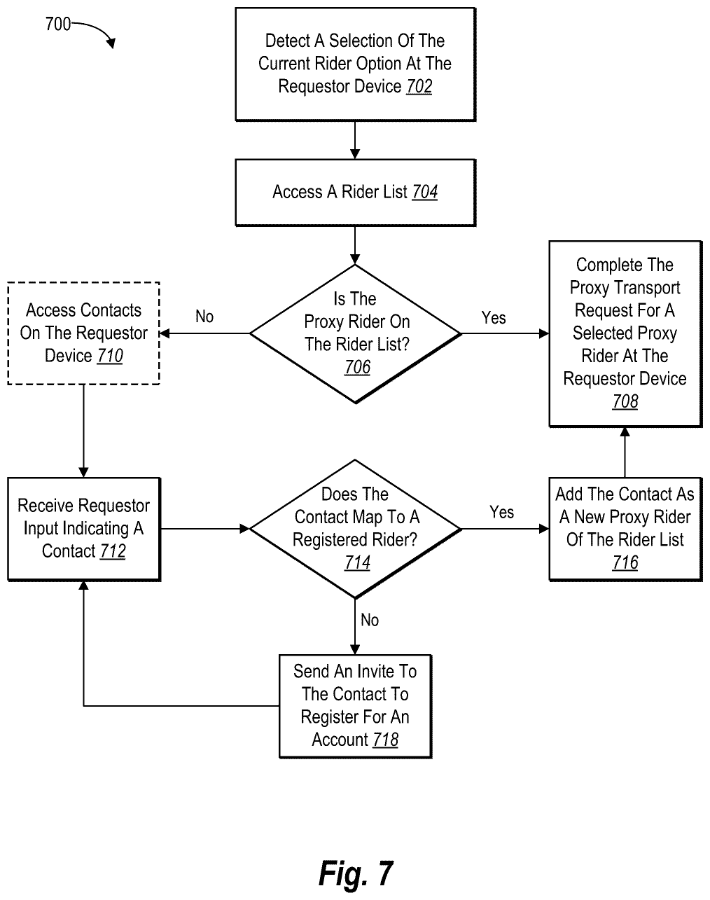

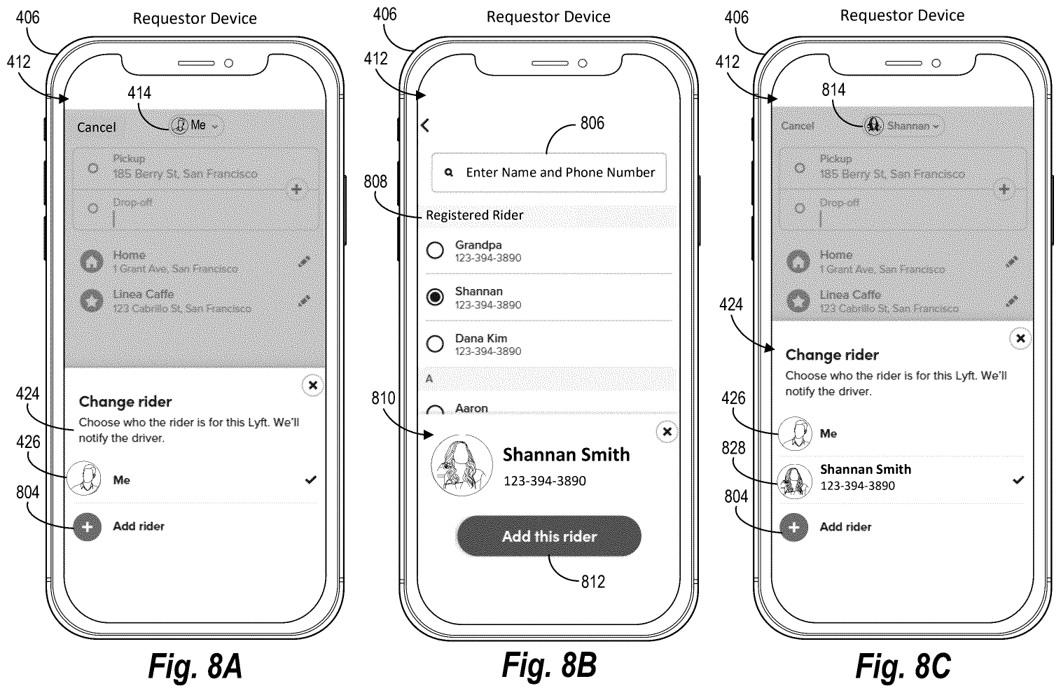

As shown in FIG. 4B, based on detecting the requestor selecting the current rider option 414 at the requestor device 406, the requestor user interface 412 updates to display a rider list 424 where the requestor can select a proxy rider for the transportation request (e.g., creating a proxy transportation request). As shown, the rider list 424 includes the requestor 426 (i.e., “Me”) and a proxy rider 426 (i.e., “Wife”). In addition, the rider list 424 includes an option to add a another proxy rider, which is described below with respect to FIGS. 7-8C.

Based on the requestor device 406 detecting a selection of the proxy rider 428 within the rider list 424, the requestor device 406 can update the transportation request to find a ride for the proxy rider 428 rather than for the requestor 426. To illustrate, FIG. 4C shows the requestor device 406 updating the requestor user interface 412 to create a proxy transportation request for the proxy rider 428. Specifically, the updated current rider option 414 in FIG. 4C shows that requestor user interface 412 has updated to provide an indication of a proxy transportation request for the proxy rider 428 (i.e., “Wife”). The proxy matching system 104 can provide an indication of a proxy transportation request in other ways, such as displaying a banner, a badge, an icon, or changing one or more colors within the requestor user interface 412. Accordingly, the proxy matching system 104 enables the requestor to utilize the requestor device 406 to generate and submit a transportation request themselves as well as a proxy transportation request for another user (e.g., the proxy rider 428).

As shown in FIG. 4C, the requestor device 406 detects input for the pickup location 416 and the dropoff location 418. In various implementations, the pickup location 416 will be at a different location than where the requestor is currently located. Indeed, a proxy transportation request enables a requestor to generate a transportation request for a proxy rider currently at another location. However, in some implementations, the requestor will generate a proxy transportation request for a proxy rider at the same location as the requestor (e.g., requestor device 406).

In addition, while not displayed, the requestor user interface 412 can include additional interfaces that include options with respect to the proxy transportation request. For example, the proxy matching system 104 enables the requestor to specify a specific pickup location (e.g., a particular airport terminal, event gate, or hotel entrance), choose a transportation mode (e.g., vehicle, scooter, bicycle, boat, helicopter, plane, carriages, etc.), select a vehicle type (e.g., shared, economy, extra seats, etc.), or modify a driver preference (e.g., specify minimum driver rating). Further, the proxy matching system 104 can provide proxy transportation request updates to the requestor device 406, such as when the proxy matching system 104 is searching for a provider or finalizing pickup details.

As shown in FIG. 4D, the requestor device 406 can receive confirmation of the proxy transportation request. For example, the requestor device 406 detects selection of the confirm and request element 430 within the requestor user interface 412. Based on the confirmation, the requestor device 406 can send the proxy transportation request (or data packets that include details of the proxy transportation request) to the proxy matching system 104 and the proxy matching system 104 can use the received data to match the proxy rider 428 to a provider device, as shown in FIG. 4E.

As mentioned above, FIG. 4E includes (from left to right), the provider device 410, the requestor device 406, and the rider device 408, where the respective user interfaces correspond to a first time period. For example, the provider device 410 is accepting the proxy transportation request, while the requestor device 406 and the rider device 408 are receiving information about the request.

As shown, the requestor user interface 412 on the requestor device 406 displays a request sent notification 436 that indicates to the requestor that the proxy matching system 104 has sent details of the proxy transportation request (e.g., a first indicator of the proxy transportation request) to the rider device 408. While the request sent notification 436 is shown as a popup notification, the proxy matching system 104 can provide the request sent notification 436 as an electronic message, text message, or another indicator.

The requestor user interface 412 can include a rider map portion 440 having a map corresponding to the location of the proxy rider (i.e., the location of rider device 408) and/or the location of the provider (i.e., the location of the provider device 410). For example, the map portion shows the current location of the rider device 408 when determining a provider match for the proxy transportation request. In addition, once the provider device 410 is determined (e.g., matched), the map portion shows the location of the provider device 410.

Additionally, the requestor user interface 412 includes a ride status portion 442. As shown, the ride status portion 442 provides information with respect to the proxy transportation request for the proxy rider, which was submitted from the requestor device 406. For example, the ride status portion 442 includes information that a provider device 110 (i.e., nearby driver) has been found.

As shown, the ride status portion 442 of the requestor user interface 412 includes a requestor-based edit ride option 444. In response to detecting a selection of the requestor-based edit ride option 444, the requestor user interface 412 can update to display one or more selectable transportation options. As mentioned previously, the requestor device 406 can communicate with the proxy matching system 104 to determine a first set of selectable transportation options corresponding to the requestor. The selectable transportation options can vary based on whether the proxy rider is pending pickup, is on their way to the dropoff location, or has been dropped off. Additional detail regarding selectable transportation options is provided below with respect to FIGS. 9-10D.

As shown in FIG. 4E, the rider device 408 includes a rider user interface 438. As shown, the rider user interface 438 can include similar elements as the requestor user interface 412. Indeed, the proxy matching system 104 can provide a first indicator of the proxy transportation request to the rider device 408, which is used to generate and display the rider user interface 438. As shown, the rider user interface 438 includes the rider map portion 440 and the ride status portion 442 (as described above). Notably, while the requestor user interface 412 and the rider user interface 438 can show similar components (e.g., elements, features, layouts, and graphics), the components can appear differently based on user preferences, customizations, and/or user input at a particular device (e.g., the requestor zooming in on the map portion 440 does not affect the zoom level of the map portion on the rider device 408).

In addition, the ride status portion 442 within the rider user interface 438 includes a rider-based edit ride option 446. The rider-based edit ride option 446 can correspond to a second set of selectable transportation options corresponding to the rider. The first set (e.g., requestor set) and second set (e.g., rider set) of selectable transportation options can include one or more of the same options and/or different options, as further provided below with respect to FIGS. 9-10D.

As mentioned above, FIG. 4E also includes the provider device 410. Here, the provider device 410 corresponds to a provider device that the proxy matching system 104 has matched to the rider to fulfill the proxy transportation request. For example, a provider corresponding to the provider device 410 indicates to the proxy matching system 104 that they are online and available to fulfill transportation requests. Further, as detailed below in connection with FIG. 14, the transportation matching system 102 and/or proxy matching system 104 matches the rider device 408 to the provider device 410.

As shown, the provider device 410 includes a provider user interface 448. The provider user interface 448 includes a provider map portion 450. Generally, the provider map portion 450 includes the location of the provider device 410. In some implementations, the provider map portion 450 can show other locations, such as the location of the rider device 408.

In addition, the provider user interface 448 shows a transportation request status portion 452. As shown, the transportation request status portion 452 includes information about the rider (e.g., rider identification information) as well as the transportation request (e.g., a second indication of the proxy transportation request). For example, the transportation request status portion 452 includes the rider's approximate location, name, picture, and rating. In addition, the transportation request status portion 452 includes an accept request selectable element 454 where the provider can accept the proxy transportation request for the proxy rider.

As mentioned above, the provider user interface 448 includes transportation request information. In particular, the provider user interface 448 includes information with respect to the proxy transportation request. However, because of the enhanced capabilities provided to the requestor device 406 in generating a proxy transportation request, the proxy matching system 104 can present the proxy transportation request to the provider device 410 as if the request originated from the rider device 408. Indeed, in many implementations, because the provider device 410 is provided with the rider identification information, the provider at the provider device 410 believes that the rider device 408 submitted a standard transportation request and is unaware that the requestor device 406 submitted a proxy transportation request for the proxy rider.

As shown in FIG. 4F, each of the user interfaces and each of the devices can update based on the provider device 410 detecting the provider accepting the proxy transportation request. As shown, the provider user interface 448 on the provider device 410 updates the provider map portion 450 to display the location of the rider (e.g., the pushpin indicating the location of the rider device 408) relative to the location of the provider device 410 (i.e., the arrow) as well as a navigational path to the rider device 408. Additionally, the provider user interface 448 updates the transportation request status portion 452 to display a contact rider selectable element 456 and a rider location arrival selectable element 458. For example, upon detecting a selection of the rider location arrival selectable element 458, the provider device 410 can provide an indicator to the proxy matching system 104 that the provider device 110 has arrived at the pickup location.

As mentioned above, the provider user interface 448 shown in FIG. 4F includes the contact rider selectable element 456. In various implementations, upon detecting a selection of the contact rider selectable element 456, the provider device 410 can initiate contact with the rider device 408 (e.g., directly or via the proxy matching system 104). For instance, the provider device 410 calls the rider device 408, such as when the provider wants to coordinate a more specific pickup location or is unable to locate the rider. As another example, the provider device 110 can send a message (e.g., text message, email, push notification, in-application message, etc.) to the rider device 408 using the rider location arrival selectable element 458. In this manner, even though the requestor device 406 submits the proxy transportation request apart from the rider and rider device 408, the provider device 410 can directly (e.g., without using the requestor as a middleman or intermediary) contact the rider device 408.

In one or more implementations, the contact information for the rider device 408 is stored on the provider device 410. For example, when the proxy matching system 104 offers the proxy transportation request to the provider device 410 (e.g., the second indication of the proxy transportation request), the proxy matching system 104 can include the rider's contact information as part of providing information about the rider, which the provider device 410 can temporarily store. If the provider device 410 accepts the proxy transportation request, the provider device 410 can link the contact information of the rider to the contact rider selectable element 456.

In some implementations, upon detecting a selection of the contact rider selectable element 456, as shown in FIG. 4F, the provider device 410 can query the proxy matching system 104 for the contact information of the rider device 408. For example, the proxy matching system 104 looks up the rider's contact information in a rider profile database and provides it to the provider device 410, which contacts the rider device 408. In alternative implementations, the proxy matching system 104 identifies the contact information of the rider device 408 (e.g., at a server device), contacts the rider device 408, and connects the provider device 410 to the rider device 408. In these implementations, the proxy matching system 104 can enable the provider to contact the rider without storing or revealing the contact information of the rider device 408 on the provider device 410.

As also shown in FIG. 4F, the rider user interface 438 on the requestor device 406 updates the rider map portion 440 to show the locations of the provider device 410 (e.g., the transportation vehicle or car) relative to the rider device 408 (e.g., the pickup location circle) as well as an estimated time of pickup. In addition, the rider user interface 438 updates the ride status portion 442 to display instructions for the rider to travel to the pickup location.

In addition, the ride status portion 442 of FIG. 4F includes the provider identification information 460. As shown, the provider identification information 460 includes the name of the provider, the provider rating, the type of transportation vehicle, a license plate number of the transportation vehicle, a picture of the provider, and a visual depiction of the transportation vehicle. The provider identification information 460 can include additional or fewer pieces of information than shown. For example, the ride status portion 442 can expand to show additional or more detailed provider identification information.

In addition, the ride status portion 442 of FIG. 4F within the rider user interface 438 includes the rider-based edit ride option 446 as well as a provider contact selectable element 466. For example, the provider contact selectable element 466 enables the rider device 408 to contact the provider device 110, which can occur in a similar manner to how the contact rider selectable element 456 on the provider device 410 enables the provider to contact the rider device 408.

In addition, as shown in FIG. 4F, the ride status portion 442 within the rider user interface 438 includes the rider-based edit ride option 446 as well as the safety tools selectable option 468, which are described above. Indeed, the proxy matching system 104 enables the rider device 408 to provide the rider with personalized options within the rider user interface 438 that may not be relevant to the requestor.

As shown in FIG. 4F, the requestor user interface 412 on the requestor device 406 updates in a similar manner as the rider user interface 438 on the rider device 408. Indeed, in various implementations, the requestor user interface 412 can match and/or synchronize with the rider user interface 438. For example, the proxy matching system 104 sends the same or similar data to both the rider device 408 and the requestor device 406 at around the same time, which causes the devices to display components with similar graphics and information. Accordingly, the requestor user interface 412 can include the same rider map portion 440 and ride status portion 442 as the rider user interface 438, which is described above in connection with FIG. 4F. Indeed, as shown, the ride status portion 442 includes the same provider identification information 460 as well as the provider contact selectable element 466.

In addition, the ride status portion 442 of FIG. 4F within the requestor user interface 412 includes the requestor-based edit ride option 444 as well as a provider contact selectable element 466, each described above. In some implementations, the requestor device 406 does not include the provider contact selectable element 466 within the ride status portion 442. In one or more implementations, the proxy matching system 104 can provide the same or similar options, such as the safety tools selectable option 468 to both the requestor device 406and the rider device 408.

As shown in FIG. 4G, the proxy matching system 104 can cause the user interfaces within the provider device 410, the requestor device 406, and the rider device 408 to further update based on the provider device 410 nearing the pickup location. To illustrate, FIG. 4G shows the provider user interface 448 on the provider device 410 updating the provider map portion 450 to show the provider device 410 arriving at the pickup location (e.g., the pushpin). In addition, the provider user interface 448 updates the transportation request status portion 452 to add a rider pickup confirmation element 470, where the provider device 410 can detect the provider confirming the pickup of the rider.

As shown on the rider device 408 of FIG. 4G, the rider user interface 438 can update the rider map portion 440 to show the provider device 410 (e.g., shown as the vehicle icon) arriving at the pickup location. Similarly, the rider user interface 438 can update the ride status portion 442 to show when the provider has arrived. For example, the ride status portion 442 indicates that the provider (e.g., a driver) is waiting at the location. Further, the ride status portion 442 can provide a decrementing timer indicating how long the provider will wait at the pickup location for the rider.

As shown in FIG. 4G, the ride status portion 442 can also display an expanded version of the provider identification information 460. As illustrated in FIG. 4G, the provider identification information 460 displays information that assists the rider to easily locate the provider when meeting at the pickup location. In some implementations, the rider user interface 438 dynamically expands the provider identification information 460 within the ride status portion 442 to indicate the arrival of the provider device 410 at the pickup location. In some implementations, the proxy matching system 104 can send other notifications (e.g., a popup notification, a text message, an email, etc.) to indicate the arrival of the provider device 410.

As also shown in FIG. 4G, the requestor device 406 can update the requestor user interface 412 is a manner similar to the rider user interface 438 (e.g., to match or synchronize with the rider user interface 438). For example, the requestor user interface 412 can update both the rider map portion 440 and the ride status portion 442 as previously described. For example, the proxy matching system 104 can send other notifications (e.g., a popup notification, a text message, an email, etc.) to indicate the arrival of the provider device 410.

However, in some implementations, the proxy matching system 104 can send notifications of the arrival of the provider to the pickup location to the rider device 408 that are not sent to the requestor device 406. Indeed, as shown in FIG. 4G, the proxy matching system 104 may provide additional active notifications to the rider device 408 to inform the rider of the provider's arrival while, at the same time, passively providing updates to the requestor device 406 with respect to the status of the rider. In this manner, the rider can proceed with the ride (i.e., transportation service) and the requestor device 406 can be updated as to when the rider is picked up and the ride starts.

Once the provider device 410 confirms picking up the rider to the proxy matching system 104, as shown in FIG. 4G, the proxy matching system 104 can start the transportation service (e.g., ride). For example, the proxy matching system 104 can cause the provider device 410 to display navigational directions to the dropoff location. In particular, the provider user interface 448 on the provider device 410 can update the provider map portion 450 to display turn-by-turn directions to the dropoff location.

In addition, the proxy matching system 104 can provide real-time status updates of the ride to both the requestor and the rider. To illustrate, FIG. 4H shows the proxy matching system 104 causing the requestor device 406 and the rider device 408 to update their respective user interfaces to show real-time status updates of the transportation service (e.g., ride). As shown in FIG. 4H, the requestor user interface 412 within the requestor device 406 updates the map portion 440 to display the current location of the provider device 410 and/or rider device 408, as described above. Indeed, the proxy matching system can utilizes one or more location services, such as GPS services, to detect and monitor to location of the rider device 408 and/or provider device 410. In this manner, the requestor, who is typically absent from the ride, can safely track the location of the rider and know when the rider safely arrives at the dropoff location or it any interruptions to the ride occurred.

As also shown in FIG. 4H, the requestor user interface 412 on the requestor device 406 can update the ride status portion 442 to show an estimated time of arrival (ETA) at the dropoff location. In addition, the ride status portion 442 can continue to display the provider identification information 460. In some implementations, the ride status portion 442 can expand to display additional information, such as trip information (e.g., the pickup location, dropoff location, and intermediate stops), ride cost, and payment information.

As mentioned above, in various implementations, the requestor device 406 can display selectable transportation options that correspond to the requestor. Further, these options may change based on if the rider is pending pickup, on their way to the dropoff location, or dropped off. To illustrate, during the ride, or a portion thereof, the requestor user interface 412 on the requestor device 406 can update the ride status portion 442 to include a tip option 472, as shown in FIG. 4H. For instance, in many cases, the requestor is paying for the ride. Thus, the proxy matching system 104 can enable the requestor device 406 to add a tip such that no payment information is required on the part of the rider. For example, if the requestor is submitting a proxy transportation request for a child, babysitter, friend, or as a gift, the requestor can book and pay for the ride (including a tip). Accordingly, the proxy matching system 104 causes the requestor device 406 to show the tip option 472 without causing the rider device 408 to show the same or similar option.

In alternative implementations, the proxy matching system 104 can cause the rider device 408 to also show the tip option 472. For instance, in some implementations, the proxy matching system 104 determines that requestor and the rider share payment access. For example, the rider is a spouse, business agent, boss, etc. In these cases, the proxy matching system 104 can cause the rider device 408 to show the add tip option and deduct the indicated tip from the total charge from the shared payment.

In some implementations, the proxy matching system 104 can cause the rider device 408 to show the add tip option based on determining a qualifying authorization of the rider. For example, if the rider has payment information stored with his or her account, the proxy matching system 104 can enable the rider to leave their own tip based on the quality and service of the ride rendered by the provider. Similarly, if the rider meets certain age and/or trustworthiness requirements, the proxy matching system 104 can enable the rider to leave a tip. In some instances, both the rider and the requestor may leave a tip. Here, the proxy matching system 104 can notify one or both users when the other user leaves a tip to avoid duplicate tipping.

As shown in FIG. 4H, the proxy matching system 104 can cause the rider device 408 to update the rider user interface 438 in a similar manner as the requestor device 406. For example, the rider user interface 438 updates the rider map portion 440 and the ride status portion 442 as described above with respect to the requestor device 406. Further, as mentioned above, the rider user interface 438 can include one or more selectable transportation options specific to the rider device 408 (e.g., safety tools) while not including selectable transportation options specific to the requestor device 406.

Upon arriving at the dropoff location, the provider device 410 can confirm the safe delivery of the rider to their destination. To illustrate, FIG. 4H shows the provider device 410 updating the provider user interface 448 to show a rider dropoff confirmation option 474. Upon the provider device 410 detecting a selection of the rider dropoff confirmation option 474, the proxy matching system 104 can end the transportation service.

Further, in various implementations, the proxy matching system 104 can further update the user interfaces of the provider device 410, the requestor device 406, and the rider device 408, as further discussed below. For example, the proxy matching system 104 updates the provider device 410 to indicate an amount earned for fulfilling the proxy transportation request. The proxy matching system 104 can update the requestor device 406 to enable the requestor to leave a tip and/or view the total ride amount. Also, the proxy matching system 104 can update the rider device 408 to leave a rating to the rider and/or provider.

Moreover, the proxy matching system 104 can send a notification to the requestor device 406 indicating the safe arrival of the rider to the dropoff location. Indeed, the proxy matching system 104 can send a message or notification to the requestor device 406 indicating the end of the ride. In some implementations, the proxy matching system 104 may send the notification based on whether the requestor device 406 is showing the requestor user interface 412 and/or a requestor application that shows the requestor user interface is active. For example, if the requestor device 406 is showing the requestor application, the proxy matching system 104 updates the requestor user interface to show the end of the ride. Otherwise, the proxy matching system 104 can send a message to the requestor device 406 indicating that the ride has ended.

As mentioned previously, the proxy matching system 104 can detect when a transportation request being submitted at a requestor device 106 is a proxy transportation request for a proxy rider rather than the requestor. To illustrate, FIG. 5 shows a state diagram of detecting a proxy transportation request at a requestor device in accordance with one or more embodiments. In particular, FIG. 5 shows a series of acts 500 for the proxy matching system 104 (and/or the transportation matching system 102) detecting a proxy transportation request being generated at a requestor device 106.

As shown, the series of acts 500 includes an act 502 of the proxy matching system 104 detecting the start of a transportation request at the requestor device 106. For example, the requestor device 106 detects a user (i.e., the requestor) initiating a transportation request by entering a pickup and/or dropoff location. In alternative implementations, the requestor device 106 detects the requestor selecting an element to start a transportation request.

The series of acts 500 includes an act 504 of the proxy matching system 104 determining if the request triggers a proxy transportation request. The proxy matching system 104 can determine if the transportation request triggers a proxy transportation request based on one or more factors. For example, if the requestor device 106 is currently participating in a ride, the proxy matching system 104 may determine that the requestor device 106 is initiating a transportation request for another rider.

As another example, the proxy matching system 104 determines a proxy transportation request trigger based on location information. For instance, upon the requestor device 106 receiving a pickup location, the proxy matching system 104 identifies a location of the requestor device 106 (e.g., based on a location input by the requestor in the proxy transportation request or using the location of the rider device 108 itself) and determines if the requestor device 106 is within a threshold pickup distance of the pickup location, such as 500 feet, a quarter-mile, one mile, five miles, 500 meters, or 1,000 meters. Indeed, if the pickup location is beyond the threshold pickup distance from the requestor device location, the proxy matching system 104 can trigger a proxy transportation request, as the transportation request is likely for another user at a different location from the requestor.

In some implementations, the proxy matching system 104 can match the pickup location to a proxy rider associated with the requestor. For example, if the requestor has a list of proxy riders, the proxy matching system 104 can identify the location of each of the proxy riders (e.g., based on their corresponding rider devices, accessible calendar data, or social media data) and compare their location to the pickup location. If the proxy matching system 104 identifies a match (e.g., a proxy rider is within the threshold pickup distance of the pickup location), the proxy matching system 104 can determine that a proxy transportation request is triggered.

In one or more implementations, the proxy matching system 104 can determine a proxy transportation request trigger based on previous requestor behavior and/or previous proxy transportation requests. For example, upon detecting a day and time pattern of submitting proxy transportation requests for a proxy rider (e.g., a child), the proxy matching system 104 determines that a subsequent transportation request is a proxy transportation request for the proxy rider.

As shown, the series of acts 500 include an act 506 of the proxy matching system 104 continuing with the transportation request for the requestor. Indeed, if the request is determined not to trigger a proxy transportation request, the proxy matching system 104 can proceed to the act 506, where the proxy matching system 104 enables the requestor to submit a standard transportation request for himself or herself.

However, if the proxy matching system 104 determines that the request triggers a proxy transportation request, the proxy matching system 104 can proceed to the act 508 of the proxy matching system 104 providing a notification to create a proxy transportation request for another user (e.g., a proxy rider notification). In particular, the proxy matching system 104 can cause the requestor device 106 to display a proxy rider notification prompting the requestor whether the transportation request being started on the requestor device 106 is for another user (i.e., a proxy rider). As described below, the requestor device 106 can provide one or more types of proxy rider notifications to the requestor indicating the detection of a potential proxy rider.

Upon providing the proxy rider notification, the proxy matching system 104 can receive requestor input in response. To illustrate, the series of acts 500 includes an act 510 of the proxy matching system 104 determining whether a selection of the current rider option is detected on the requestor device 106. In alternative implementations, the proxy matching system 104 can determine whether the requestor provides another positive or negative response to the proxy rider notification. If the requestor does not select the current rider option (or otherwise provides a negative response), the proxy matching system 104 can return to the act 506 of continuing with the transportation request, as described above.

Otherwise, as shown, the series of acts 500 includes an act 512 of the proxy matching system 104 identifying the requestor selecting a proxy rider. For example, in response to the proxy rider notification, the requestor selects the current rider option, and in response, the proxy matching system 104 can cause the requestor device 106 to update a requestor user interface to show a rider list, as described above. Additionally, the requestor device 106 can detect the selection of a proxy rider from the rider list.

As shown, the series of acts 500 include an act 514 of the proxy matching system 104 receiving a proxy transportation request from the requestor device 106 for the proxy rider. In particular, upon selecting a proxy rider, the proxy matching system 104 enables the requestor to complete and submit a proxy transportation request for the proxy rider from the requestor device 106.

To illustrate the series of acts 500, FIGS. 6A-6C show example graphical user interfaces of detecting a proxy transportation request trigger. In particular, FIGS. 6A-6C show graphical user interfaces on a requestor device corresponding to detecting a proxy transportation request at the requestor device in accordance with one or more embodiments. For simplicity, FIGS. 6A-6C refer to the requestor device 406 and the requestor user interface 412 introduced above with respect to FIGS. 4A-4H.

As shown in FIG. 6A, the requestor device 406 includes the requestor user interface 412 having text input fields for the pickup location 416 and the dropoff location 418. Additionally, the requestor user interface 412 includes a list of potential dropoff locations 420 (e.g., popular or previously selected dropoff locations), which can be editable by the requestor. Further, the requestor user interface 412 includes the current rider option 414, as disclosed above.

As shown, the requestor user interface 412 also includes a proxy rider notification 602. As disclosed above, the proxy matching system 104 can cause the requestor device 406 to show the proxy rider notification 602 based on triggering a proxy transportation request. For example, the proxy matching system 104 triggers a proxy transportation request based on the pickup location 416 entered by the requestor being beyond a threshold pickup distance from the location of the requestor device 406, as described above.

While FIG. 6A shows the proxy rider notification 602 as a popup graphic or element, the requestor device 406 can provide a variety of notification types. For example, the requestor device 106 displays a push notification. As another example, the requestor user interface 412 provides a modal element that requires the requestor to indicate whether the transportation request is from himself or herself or for another rider.

In various implementations, the requestor can respond to the proxy rider notification by selecting the current rider option 414. In response, the proxy matching system 104 can cause the requestor device 406 to show the requestor a list of riders. To illustrate, FIG. 6B shows a rider list 424. As shown, the rider list 424 includes the requestor 426 (i.e., “Me”) and a proxy rider 428 (i.e., “Shannan”). In addition, the rider list includes an add proxy rider element 604 that enables the requestor to add additional proxy riders to the list, which is further described below with respect to FIGS. 7-8C. In this manner, the requestor device 406 can detect a selection of a proxy rider from the rider list 424 in connection with generating a proxy transportation request on the requestor device 406.

Indeed, based on the requestor device 406 detecting a selection of the proxy rider 428 within the rider list 424, the requestor device 406 can modify the transportation request to a proxy transportation request for a rider other than the requestor (e.g., the proxy rider). To illustrate, FIG. 6C shows the requestor user interface 412 on the requestor device 406 updating to show an updated current rider option 614 where the proxy rider 428 (i.e., “Shannan”) is the currently selected rider. In this manner, the transportation request is now a proxy transportation request being submitted for the proxy rider Shannan from the requestor device 406.

As mentioned above, the proxy matching system 104 enables a requestor to select a proxy rider at the requestor device. Often, the proxy rider is stored on a rider list. However, if the proxy rider is not on the rider list, the proxy matching system 104 can add the rider to the rider list. To illustrate, FIG. 7 shows a state diagram of adding and selecting proxy riders for a transportation request at a requestor device in accordance with one or more embodiments. In particular, FIG. 7 shows a series of acts 700 for the proxy matching system 104 (and/or the transportation matching system 102) detecting a proxy transportation request being generated at a requestor device 106.

As shown, the series of acts 700 includes an act 702 of the proxy matching system 104 detecting a selection of the current rider option at the requestor device 106. For example, based on the proxy matching system 104 detecting a proxy transportation request trigger and/or providing a proxy rider notification, as described above, the proxy matching system 104 can detect the requestor selecting the current rider option at the requestor device 106.

In response to detecting a selection of the current rider option, the proxy matching system 104 can perform an act 704 of accessing a rider list, as shown in the series of acts 700. In various implementations, the rider list includes the requestor as a default rider selection. The rider list can also include proxy riders previously added by the requestor. Further, the rider list can include an option to add, remove, or modify proxy riders on the list.

As shown, the series of acts 700 includes an act 706 of the proxy matching system 104 determining whether the proxy rider is on the rider list. For example, if the proxy rider is on the rider list (e.g., following the yes branch), the requestor device 106 can detect the selection of a proxy rider and proceed to an act 708 of the series of acts 700. Otherwise (e.g., following the no branch), the proxy matching system 104 proceeds to the act 710 of the series of acts 700.

As shown, the series of acts 700 includes an act 708 of the proxy matching system 104 completing the proxy transportation request for a selected proxy rider at the requestor device 106. For example, as described above, the requestor device 106 can guide the requestor through the process of completing and submitting the proxy transportation request for the selected proxy rider.

If it is determined that the proxy rider is not on the list, the proxy matching system 104, as described above, proceeds to an act 710 of the series of acts 700. As shown, the act 710 includes the proxy matching system 104 optionally accessing contacts on the requestor device 106. For example, the proxy matching system 104 prompts the requestor for permission to access the requestor's contact list. By accessing contacts stored locally on the requestor device 106, the proxy matching system 104 can retrieve identifier information for each of the contacts, such as names and phone numbers. In some instances, the proxy matching system 104 can access additional or alternative contact information such as email addresses, home or work addresses, screen names, social media handles, and/or other contact information.

As also shown, the series of acts 700 includes an act 712 of the proxy matching system 104 receiving requestor input indicating a contact. For example, based on the act 710, the proxy matching system 104 imports a list of contacts into the requestor user interface on the requestor device 106 and the requestor selects a contact as the proxy rider. In implementations where the act 710 is skipped, the proxy matching system 104 enables the requestor to directly enter in contact information for a contact, such as a name, phone number, and/or email address of the contact.

For one or more contacts access from the requestor device 106, or for a manually entered contact, the proxy matching system 104 can determine whether the contact maps to a registered rider, as shown in an act 714 of the series of acts 700. For example, the proxy matching system 104 compares a contact to a list of registered riders of the proxy matching system 104 (and/or transportation matching system 102) to determine whether the contact maps to a known user account. More particularly, in one or more implementations, the act 714 can include the proxy matching system 104 comparing an identifier of one or more contacts to a rider profile database (i.e., user profile database) to determine matches between contacts from the requestor device 106 and registered riders (e.g., registered users) of the proxy matching system 104 (and/or the transportation matching system 102).

To illustrate, in one or more implementations, the proxy matching system 104 identifies a phone number of a contact from the requestor device 106. For instance, a contact stored on the requestor device 106 includes the phone number and/or the requestor manually enters the phone number. The proxy matching system 104 can then determine if the same phone number is included in a rider profile database. If yes, the proxy matching system 104 can access the registered rider profile information associated with the proxy rider.

As mentioned above, the proxy matching system 104 can map an identifier from the requestor device 106 to a rider profile database to determine whether a match to a registered rider exists. Often, the proxy matching system 104 utilizes an identifier of a contact from the requestor device 106 that uniquely identifies the contact, such as a phone number or email address rather than a name. For example, the requestor may save a contact on the requestor device 106 with a pseudonym, alias, or nickname (e.g., mom, husband, or teacher); a name variant (e.g., Jess for Jessica); or a partial name (e.g., first name or last name only), where the name of the contact does not match the registered name of the contact. Accordingly, while the contact could correspond to a registered rider, the proxy matching system 104 cannot identify the contact within the rider profile database based on using the contact name alone.

As another issue, when trying to identify a registered rider (i.e., a proxy rider) based on a contact's name, the proxy matching system 104 can identify multiple potential registered riders. Indeed, even when the requestor device 106 has the full name of a contact, if the name is common, the proxy matching system 104 may not be able to confidently identify the contact in the rider profile database. Accordingly, by utilizing an identifier of a contact that uniquely identifies the contact (e.g., a phone number or email address), the proxy matching system address these issues.

As mentioned above, the proxy matching system 104 can provide rider identification information accessed from the rider profile database to a provider device 110 as part of a proxy transportation request. For example, the proxy matching system 104 accesses the name that the proxy rider used to register their account, a verified phone number, and an up-to-date rider rating. In this manner, the proxy matching system 104 can transmit sends the proxy rider's registered name (e.g., John Smith) and other verified information about the rider (e.g., the rider's rating) to the provider device 110 (rather than a pseudonym, such as husband, which may confuse the provider).

As shown in FIG. 7, based on identifying the contact as a registered rider (e.g., a known user) of the proxy matching system 104, the series of acts 700 includes an act 716 of the proxy matching system 104 adding the contact as a new proxy rider to the rider list. In some implementations, the proxy matching system 104 can automatically select the rider and continue to the act 708 of the proxy matching system 104 completing the proxy transportation request for the selected proxy rider at the requestor device 106, as described above. In addition, the proxy matching system 104 can add the known rider to the rider list on the requestor device 106 and enable the requestor to select the rider before continuing to the act 708.

If the proxy matching system 104 cannot map the contact to a registered rider, the proxy matching system 104 can proceed to an act 718 of sending an invite to the contact to register for an account on the proxy matching system 104 and/or transportation matching system 102, then proceed back to the act 712. For example, in one or more implementations, the proxy matching system 104 sends a message to the phone number or email address obtained from the contact information stored on the requestor device 106. The message can invite the contact to create an account, which the proxy matching system 104 stores in the rider profile database. Further, the proxy matching system 104 can provide a notification on the requestor device 106 that an invitation has been sent and/or if the contact registers.

In some implementations, the proxy matching system 104 enables the contact to become a proxy rider without registering for a user account at the transportation matching system 102. For example, the proxy matching system 104 allows the contact to continue as a guest and/or utilizes a web-interface to receive updates with respect to the proxy transportation request and the subsequent transportation service. In these implementations, the proxy matching system 104 can receive information from the contact, such as a name to provide the provider device 110 to assist the provider in meeting the contact at the pickup location.

As described above, the proxy matching system 104 can provide the rider list to a requestor on the requestor device 106. Further, as previously described, the proxy matching system 104 can provide options for the requestor to add proxy riders to the rider list. In addition, the proxy matching system 104 can provide options to the requestor to modify and/or remove proxy riders from the rider list. For instance, the rider can delete proxy riders from the rider list.

In one or more implementations, the proxy matching system 104 automatically removes proxy riders from the ride list. For example, if the proxy matching system 104 detects that the identifier (e.g., phone number or email address) used to map the contact to a registered rider in the rider profile database changes, the proxy matching system 104 can remove the proxy rider from the rider list. If desired, the requestor can add the proxy rider back to the list with the updated identifier. In this manner, the proxy matching system 104 can protect the privacy of the proxy rider as well as any person who is issued the old identifier (e.g., in the case of a phone number being reissued to a stranger).

In a similar manner, in various implementations, a proxy rider can opt-out of being on the rider list of another user. For example, if an employee leaves a company, the employee can select an option to remove their name from the rider list of others at the company who have previously submitted proxy transportation requests on their behalf. Likewise, the proxy matching system 104 can enable a rider to access a listing shown each requestor for whom the rider is listed as a proxy rider.

To illustrate the series of acts 700, FIGS. 8A-8C show example graphical user interfaces of adding a proxy rider to a rider list. In particular, FIGS. 8A-8C show graphical user interfaces of maintaining a list of proxy riders at a requestor device in accordance with one or more embodiments. For simplicity, FIGS. 8A-8C refer to the requestor device 406 and the requestor user interface 412 introduced above with respect to FIGS. 4A-4H.

As shown in FIG. 8A, the requestor device 406 includes the requestor user interface 412 showing the rider list 424 described above in connection with FIG. 4B. As mentioned above, the rider list 424 includes the requestor 426 (i.e., “Me”), who is selected as the current rider, as indicated by the graphic and label associated with the current rider option 414. As also shown, the rider list includes an add proxy rider element 804 that enables the requestor to add additional proxy riders to the list.

In one or more implementations, the proxy matching system 104 can limit the number of proxy riders shown on the rider list 424 at one time. For example, the rider list is limited to ten users. In some implementations, the proxy matching system 104 automatically, or based on a user selection, removes a proxy rider when adding a proxy rider when the rider list 424 includes the maximum number of proxy riders.

In some implementations, the proxy matching system 104 can maintain multiple rider lists for a requestor. For example, the requestor user interface 412 includes multiple rider lists indicated by tabs across the top or bottom of the rider list (or otherwise displayed). Accordingly, the proxy matching system 104 enables the requestor to maintain multiple rider lists, such as saving a friend rider list, work rider list, classmates rider list, etc.

As mentioned above, in one or more implementations, upon detecting a selection of the add proxy rider element 804, the proxy matching system 104 can prompt the requestor to allow the proxy matching system 104 access to the contacts on the requestor device 406. Based on the requestor granting access, the proxy matching system 104 can match contacts on the requestor device 406 to registered riders on the proxy matching system 104 (and/or transportation matching system 102).

In various implementations, the proxy matching system 104 can display one or more notices, messages, and/or graphics to the requestor with respect to adding a proxy rider. For example, the proxy matching system 104 can cause the requestor device 406 to display one or more messages that provide an overview of generating ride requests for other users (e.g., a proxy transportation request). In some implementations, the requestor device 406 displays a message establishing parameters of a proxy transportation request, such as indicating that the proxy rider must be an adult, over a certain age, and/or have consent from a parent or guardian.

As described above, the proxy matching system 104 can show the requestor one or more identified registered riders and/or allow the requestor to manually enter in a contact's information. To illustrate, FIG. 8B shows the requestor device 406 updating the requestor user interface 412 to show a contact search field 806 where the requestor can manually enter information for the contact, such as a name, phone number, email address, etc. Based on this entered information, the proxy matching system 104 can search contacts on the requestor device 406 and/or registered riders in a rider profile database, as described above.

Additionally, the requestor user interface 412 updates to show a registered riders list 808. For example, in one or more implementations, upon receiving access to contacts on the requestor device 406, the proxy matching system 104 identifies each of the contacts mapped to a registered rider. Further, as shown, the proxy matching system 104 can display these matched registered riders in the registered riders list 808.

As shown, the requestor device 406 detects a selection of a registered rider (i.e., “Shannan”) from the registered riders list 808. In response, the requestor user interface 412 can update to display a rider confirmation element 810 that show the matched registered rider as well as includes an add rider element 812. In various implementations, the rider confirmation element 810 provides rider identification information from the rider profile data. For example, the rider confirmation element 810 shows the registered name of the proxy rider rather than the name stored on the requestor device 406. Indeed, the requestor device 406 may store only the rider's first name, while the proxy matching system 104 retrieves and displays the rider's full name.

If the proxy matching system 104 detects selection of the rider element 812, the proxy matching system 104 can add the selected rider to the rider list 424. Otherwise, the proxy matching system 104 can detect cancelation of the rider confirmation element 810 and not add the rider to the rider list 424. In some implementations, upon selecting a rider from the registered riders list 808, the proxy matching system 104 adds the selected proxy rider to the rider list 424 without receiving additional confirmation from the requestor.

As shown in FIG. 8C, the requestor device 406 updates the requestor user interface 412 by adding the selected rider to the rider list 424. Indeed, the rider list 424 shows the proxy matching system 104 adding the proxy rider 828 (i.e., “Shannan”) to the rider list 424 on the requestor device 406. Further, based on the proxy rider 828 being selected (as shown), the current rider option 814 updates to show the picture and name of the proxy rider (i.e., “Shannan”) rather than the requestor (i.e., “Me”) indicating that the transportation request has changed to a proxy transportation request on the requestor device 406.

Turning now to the next set of figures, FIGS. 9-10D correspond to sets of selectable transportation options with respect to requestors and proxy riders. To illustrate, FIG. 9 shows a diagram of determining available features for a requestor device and a rider device with respect to a proxy transportation request in accordance with one or more embodiments. FIGS. 10A-10D show example graphical user interfaces of different selectable transportation options made available to a requestor device and a rider device.

As shown, FIG. 9 includes a ride database 902 within the proxy matching system 104 and the transportation matching system 102. In some implementations, the ride database 902 is located on a computing device separate from the proxy matching system 104 and/or transportation matching system 102.

In various implementations, the ride database 902 includes ride objects corresponding to transportation requests and proxy transportation requests. For example, as shown, the ride database 902 includes a first ride object 904 and a second ride object 905. The first ride object 904 can correspond to a standard transportation request where the requestor is requesting a ride for himself or herself. Accordingly, the first ride object includes a requestor identifier 907 having a requestor information set 910.

In various implementations, the requestor information set 910 includes data associated with a transportation request, such as the pickup and dropoff location, requestor information, transportation preferences, and/or other transportation request information. For example, the requestor information set 910 can include a list of selectable transportation options that are available to the requestor before, during, and after the transportation service. In some implementations, the requestor information set 910 can also include information about the transportation service, such as the current location, estimated arrival time, provider identification information, etc. In alternative implementations, the transportation service information is stored in another database, such as a trip database.

As shown, the second ride object 905 can correspond to a proxy transportation request where the requestor is a separate or different person than the rider. As described above, a requestor device 106 submits a proxy transportation request for a proxy rider associated with a separate rider device 108. As shown in FIG. 9, because the second ride object 905 is associated with a proxy transportation request, the second ride object 905 includes two information sets. For example, the second ride object 905 includes a requestor information set 914 associated with the requestor identifier 912 as well as a proxy rider information set 918 associated with the proxy rider identifier 916.

In many implementations, the data within the requestor information set 914 and the proxy rider information set 918 overlaps. For example, details regarding the pickup and dropoff location, provider identification information, and transportation preferences can match. While data can match between the two information sets, in some implementations, the requestor information set 914 also includes different selectable transportation options than the proxy rider information set 918. For instance, the requestor information set 914 may include options corresponding to setting up a proxy transportation request (e.g., adding and changing the locations, adding stops, paying for the service) while the requestor information set 914 includes option corresponding to passenger safety during the proxy transportation service (e.g., report an emergency or leave a review).

To illustrate, FIG. 9 shows a requestor device 906 with a set of requestor selectable transportation options 930 and a rider device 908 with a set of rider selectable transportation options 932. As shown, the requestor selectable transportation options 930 in the requestor device 906 includes an overlapping selectable transportation option with the rider selectable transportation options 932. As also shown, many of the selectable transportation options are different between the requestor selectable transportation options 930 and the rider selectable transportation options 932.

When a transportation request is generated and matched to a provider device 110 the proxy matching system 104 can add a ride object like the first ride object 904 to the ride database 902. Likewise, when a proxy transportation request is detected, the proxy matching system 104 can create a ride object like the second ride object 905 to the ride database 902. Indeed, for a proxy transportation request, the proxy matching system 104 can generate a single ride object that includes two sets of information. The proxy matching system 104 can also update indexes in corresponding databases (e.g., a trip database) to provide the requestor device 906 with transportation service information between the rider device 908 and a provider device.

To illustrate, the requestor device 906 can poll the ride database 902 with a ride query (e.g., “Do I have a ride?”) to determine if a transportation service is pending. Additionally, the requestor device 906 can also poll the ride database 902 with a proxy request query (e.g., “Do I have a requested ride for a proxy rider?”) to determine if a transportation service is pending for proxy rider for a whom the requestor device 906 should be granted access. In some implementations, the proxy matching system 104 minimizes back-end overload by only performing the proxy request query for requestor devices that have the ability to generate proxy transportation requests, have previously submitted proxy transportation requests, and/or have one or more stored proxy riders on a rider list.

To illustrate, FIGS. 10A-10D show graphical user interfaces of providing different features to a requestor device and a rider device with respect to a proxy transportation request in accordance with one or more embodiments. As with previous graphical user interface figures, FIGS. 10A-10D include the requestor device 406 and the requestor user interface 412 introduced above with respect to FIGS. 4A-4H.

As described above, the proxy matching system 104 can provide a first set of selectable transportation options to the requestor device 406 before, during, and after a transportation request is rendered for the proxy rider. Similarly, the proxy matching system 104 can provide a second set of selectable transportation options to the rider device 408. To illustrate, FIG. 10A shows the requestor user interface 412 on the requestor device 406 showing a set of pre-ride requestor options 1002 that the proxy matching system 104 makes available to the requestor before the proxy rider starts their transportation service (and after the proxy transportation request is submitted to the proxy matching system 104).

As shown, the pre-ride requestor options 1002 include an option to cancel the ride for the proxy rider, add additional stops, and modify payment information. In alternative implementations, the pre-ride requestor options 1002 can include additional, fewer, or different selectable transportation options. Further, while the pre-ride requestor options 1002 are shown together in a single set, the proxy matching system 104 can make one or more of these options available in additional and/or other portions of the requestor user interface 412 as the requestor completes and submits a proxy transportation request.

To illustrate, in some implementations, the pre-ride requestor options 1002 include transportation modes. For example, the rider user interface 438 on the rider device 408 displays a set of pre-ride requestor options 1002 (i.e., the first set of selectable transportation options corresponding to the requestor device 406) that enables the requestor to select between a standard vehicle, an autonomous vehicle, a bicycle, a scooter, or another transportation modes (e.g., a boat, plane, helicopter, carriage, etc.) for the proxy transportation request. In alternative implementations, the pre-ride requestor options 1002 exclude transportation modes for a proxy transportation request. For example, in some embodiments, while a requestor can directly book a scooter for himself or herself, in various implementations, the proxy matching system 104 does not make this transportation mode available within the pre-ride requestor options 1002 as part of a proxy transportation request.

As shown, the rider user interface 438 on the rider device 408 displays a set of pre-ride rider options 1004. In one or more implementations, the proxy matching system 104 makes the pre-ride rider options 1004 available to a rider on a rider device 408 after providing the rider device 408 with an indication that a proxy transportation request has been submitted for the rider and before the transportation service begins (e.g., before the provider picks up the rider). As illustrated, the pre-ride rider options 1004 includes options of canceling the ride, contacting the driver, and contacting the requestor. The pre-ride rider options 1004 can include additional, fewer, or different selectable transportation options than shown.

As mentioned above, the requestor user interface 412 can be part of a requestor application on the requestor device 406. In these implementations, the requestor application can poll the proxy matching system 104 for selectable transportation options to show within the requestor user interface 412. For example, the requestor device 406 provides a requestor identifier (e.g., requestor_id) to the proxy matching system 104. In response, the proxy matching system 104 utilizes the requestor identifier to locate a corresponding ride object in the ride database. Further, the proxy matching system 104 can identify and provide selectable transportation options to the requestor device 406 from the requestor information set associated with the requestor identifier. The proxy matching system 104 can perform similar actions for the rider device 108 based on the rider identifier.

In various implementations, upon receiving a query from the requestor device 406, the proxy matching system 104 can return a list of features available to the requestor device 406 in connection with a proxy transportation request (e.g., based on the requestor's role). In some implementations, the proxy matching system 104 utilizes tags to identify this list of features available to a requestor.

In a similar manner, the proxy matching system 104 can apply a filtering scheme to identify and provide a list of features (e.g., selectable transportation options) available to a rider device 408 in connection with a proxy transportation request. To illustrate, in one or more implementations, the filtering scheme includes accessing the requestor set of information from a rider object to identify selectable transportation options available to the requestor device 406. For example, the requestor set of information includes ride payment information and options to modify the destinations of the proxy transportation request. The filtering scheme can also include accessing the rider set of information from the same rider object to identify selectable transportation options available to the rider device 408, as described above in connection with FIG. 9. For example, the rider set of information includes the safety tools disclosed above (e.g., an emergency call option).

In some implementations, the requestor device 406 and the rider device 408 utilize the same transportation application rather than separate applications. In these implementations, the proxy matching system 104 can cause the applications to display different user interfaces based on whether the devices are associated with the role of a requestor or a rider for a proxy transportation request. For example, as described above, the proxy matching system 104 can return a first list of selectable transportation options to the requestor device 406 and a second list of selectable transportation options to the rider device 408 based on the two devices being associated with different transportation roles.

Further, in the above implementations, the proxy matching system 104 can cause the transportation application to start the user interface at different user interface entry points based on the different transportation roles associated with the two devices. For example, the proxy matching system 104 causes the requestor device 406 to start at an interface where the requestor can start a proxy transportation request while the proxy matching system 104 starts the rider device 408 at an interface showing that a proxy transportation request has been submitted and/or a provider device 110 has been identified.

As mentioned above, the selectable transportation options can vary based on the current status of the proxy transportation request and/or transportation service. To illustrate, FIG. 10B shows the requestor device 406 and the rider device 408 displaying selectable transportation options during a transportation service. In particular, the requestor user interface 412 on the requestor device 406 shows a set of mid-ride requestor options 1006 (i.e., the first set of selectable transportation options corresponding to the requestor device 406) while the rider user interface 438 on the rider device 408 shows a set of mid-ride rider options 1008.

In various implementations, the proxy matching system 104 can update the requestor device 406, rider device 408, and a provider device in response to the requestor device 406 detecting selection of a mid-ride requestor options 1006. For example, while the requestor is not participating in the ride, the requestor device 406 can detect the selection of “Add Stop” or “Edit Drop-Off” (e.g., a location change option) Further, the proxy matching system 104 can receive an updated dropoff location and/or new stop (e.g., a location modification) for the transportation service from the requestor at the requestor device 406. In response, the proxy matching system 104 sends an update to the rider device 408 of the location modification, which causes the rider user interface 438 to update to show the updated dropoff location and/or the new stop. Likewise, the proxy matching system 104 sends an update to the provider device of the location modification, which causes the provider user interface on the provider device to change to show the location modification.

As illustrated in FIG. 10B, the selectable transportation options vary between the requestor device 406 and the rider device 408. While one or more of the selectable transportation options can overlap, the requestor device 406 and the rider device 408 can provide different selectable transportation options based on the different roles of the requestor and the rider.

In one or more implementations, the proxy matching system 104 may determine to provide more selectable transportation options to the rider device 408 based on permissions and/or authorizations of the rider. For example, if the rider is a spouse and/or shares payment with the requestor, the rider may be authorized to modify the dropoff location and/or add stops (e.g., a location change option) along the way. In some implementations, the requestor may enable the rider device 108 access to particular selectable transportation options. In these implementations, the proxy matching system 104 can make these selectable transportation options available to the requestor device 406 as well as the rider device 408. In alternative implementations, the proxy matching system 104 enables a rider device 408 to contact the requestor device 406 so that the requestor device 406 can make or approve a change requested as the rider device 408.

In addition, to selectable transportation options, the proxy matching system 104 can provide different levels of information to the requestor device 406 and the rider device 408. To illustrate, FIG. 10C includes the requestor user interface 412 on the requestor device 106 and the rider user interface 438 on the rider device 408 showing the ride status portion 442. In particular, the requestor user interface 412 includes payment information 1010 on the requestor device 406 (i.e., the first set of selectable transportation options corresponding to the requestor device 406), which includes an estimated cost of the transportation service, the payment type, and an option to modify payment settings. On the rider device 408, the rider user interface 438 shows no payment 1012 required. Indeed, when each of the devices polls the proxy matching system 104, the proxy matching system 104 can identify the corresponding roles (e.g., utilizing the respective information sets in the ride object) and return the corresponding transportation options and information (e.g., payment information 1010 and options to the requestor device 406 and no payment 1012 to the rider device 408).

FIG. 10D shows the requestor device 406 and the rider device 408 displaying selectable transportation elements after a transportation service. In particular, the requestor user interface 412 on the requestor device 406 shows a set of post-ride requestor elements 1014 (i.e., the first set of selectable transportation options corresponding to the requestor device 406) while the rider user interface 438 on the rider device 408 shows a set of post-ride rider elements1016. As shown, the requestor device 406 enables the requestor to leave a tip within the post-ride rider elements1014 using the stored payment information while the rider device 408 does not display an equivalent element. In alternative implementations, as described above, the proxy matching system 104 can enable the rider device 408 to also leave a tip.

Likewise, the rider device 408 includes a rating element within the post-ride rider elements1016. For example, because the rider experienced the ride, the proxy matching system 104 causes the rider device 408 to display the rating element. For similar reasons, as the requestor did not participate in the ride, the proxy matching system 104 can hide the ride rating element from the requestor device 406. In alternative implementations, the proxy matching system 104 can provide the rating element to the requestor device 406 as part of the post-ride requestor elements 1014.

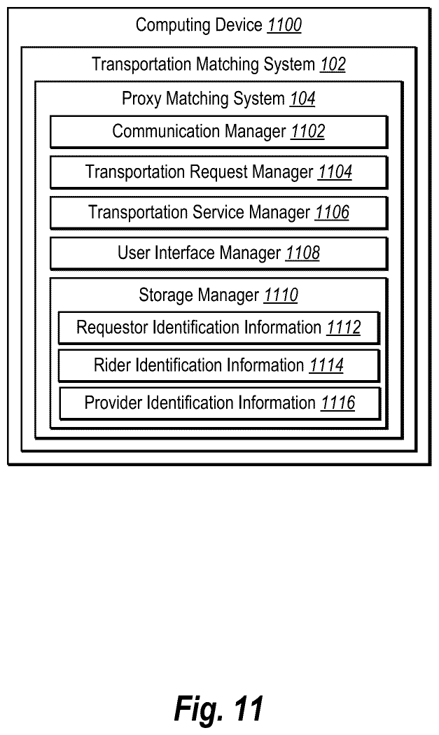

Looking now to FIG. 11, additional detail is provided regarding the components and capabilities of the proxy matching system 104 in accordance with one or more embodiments. Specifically, FIG. 11 illustrates a schematic diagram of the proxy matching system 104 on a computing device 1100 that includes the transportation matching system 102 and the proxy matching system 104. The computing device can represent one or more of the requestor device 106, 406, 906, the rider device 108, 408, 908, the provider device 110, and/or the server device 101 described above. Indeed, some or all the components of the transportation matching system 102 and/or proxy matching system 104 are implemented on a server device or client device.

As shown, the transportation matching system 102 is located on the computing device 1100. In general, the computing device 1100 represents various types of computing devices. For example, in some embodiments, the computing device 1100 is a non-mobile device, such as a desktop or server, or another type of computing device. In other embodiments, the computing device 1100 is a mobile device, such as a laptop, a tablet, a mobile telephone, a smartphone, etc. In some implementations, some or all the components of the transportation matching system 102 and/or proxy matching system 104 are implemented across multiple server devices and/or client devices. Additional details regarding the computing device 1100 are discussed below as well as with respect to FIG. 13.

The proxy matching system 104 includes various components for performing the processes and features described herein. For example, the proxy matching system 104 includes a communication manager 1102, a transportation request manager 1104, a transportation service manager 1106, a user interface manager 1108, and a storage manager 1110, which includes requestor identification information 1112, rider identification information 1114, and provider identification information 1116. Each of these components is further described below.

As shown, the proxy matching system 104 includes the communication manager 1102. In various implementations, the communication manager 1102 facilitates communications between user devices and the proxy matching system 104 and/or transportation matching system 102. For example, the communication manager 1102 provides input from a requestor device for submitting a proxy transportation request. As another example, the communication manager 1102 provides data from the proxy matching system 104 that causes a rider device to show provider identification information 1116 within a rider user interface. Similarly, the communication manager 1102 provides data from the proxy matching system 104 to cause a provider device to display the rider identification information 1114 with respect to a proxy transportation request submitted by a requestor device. Moreover, the communication manager 1102 can provide data to a requestor device 106 that enables the requestor device 106 to show real-time updates of a ride (i.e., transportation service) between the proxy rider and the provider.

As shown, the proxy matching system 104 includes the transportation request manager 1104. In various implementations, the transportation request manager 1104 facilitates the initiation, completion, and matching of transportation requests, including proxy transportation requests. In various implementations, the transportation request manager 1104 can detect a proxy transportation request being initiated in a requestor device, as disclosed above, and assist a requestor to add a proxy rider to the proxy transportation request. In addition, as described below in connection with FIG. 14, the transportation request manager 1104 can communicate with the transportation matching system 102 and/or a vehicle subsystem 1408 to pair riders to providers with respect to transportation requests and proxy riders.

As shown, the proxy matching system 104 includes the transportation service manager 1106. In various implementations, the transportation service manager 1106 coordinates transportation services (e.g., rides) between riders and providers. For example, the transportation service manager 1106 can facilitate and oversee safely transporting riders from pickup locations to dropoff locations. The transportation service manager 1106 can also provide transportation service updates to the proxy matching system 104, which can be passed on to requestor devices, rider devices, and/or provider devices.

As mentioned, the proxy matching system 104 includes a user interface manager 1108. In particular, the user interface manager 1108 can manage, maintain, provide, display, cause to be displayed, present, render, or identify information pertaining to a user interface such as a requestor user interface, rider user interface, and/or a provider user interface. For example, the user interface manager 1108 can provide a requestor user interface for display on a requestor device for a transportation service between a rider and a provider, such as those described above. In addition, the user interface manager 1108 can receive user input (or indications of user input) such as selections of transportation options or elements. Further, the user interface manager 1108 can communicate with the communication manager 1102 to present, display, or caused to be displayed user interfaces pertaining to proxy transportation requests and/or transportation services.

The proxy matching system 104 further includes a storage manager 1110. In particular, the storage manager 1110 manages, maintains, stores, accesses, retrieves, receives, provides, and or otherwise identifies information within a database. For example, the storage manager 1110 stores, accesses, and communicates other components of the proxy matching system 104 rules, algorithms, or formulas for transportation requests, proxy transportation requests, and transportation services. In some embodiments, the storage manager 1110 further stores and accesses user profile information within a database, such as the requestor identification information 1112, rider identification information 1114, and provider identification information 1116, as described above.

In one or more embodiments, each of the components of the proxy matching system 104 is in communication with one another using any suitable communication technologies. Additionally, the components of the proxy matching system 104 can be in communication with one or more other devices including one or more client devices described above. It will be recognized that although the components of the proxy matching system 104 are shown to be separate in FIG. 11, any of the subcomponents may be combined into fewer components, such as into a single component, or divided into more components as may serve a particular implementation. Furthermore, although the components of FIG. 11 are described in connection with the proxy matching system 104, at least some of the components for performing operations in conjunction with the proxy matching system 104 described herein may be implemented on other devices within the system.

The components of the proxy matching system 104 can include software, hardware, or both. For example, the components of the proxy matching system 104 can include one or more instructions stored on a computer-readable storage medium and executable by processors of one or more computing devices (e.g., the computing device 1100). When executed by the one or more processors, the computer-executable instructions of the proxy matching system 104 can cause the computing device 1100 to perform the methods described herein. Alternatively, the components of the proxy matching system 104 can comprise hardware, such as a special purpose processing device to perform a certain function or group of functions.

Additionally or alternatively, the components of the proxy matching system 104 can include a combination of computer-executable instructions and hardware.

Furthermore, the components of the proxy matching system 104 performing the functions described herein may, for example, be implemented as part of a stand-alone application, as a module of an application, as a plug-in for applications including content management applications, as a library function or functions that may be called by other applications, and/or as a cloud-computing model. Thus, the components of the proxy matching system 104 may be implemented as part of a stand-alone application on a personal computing device or a mobile device. Alternatively or additionally, the components of the proxy matching system 104 may be implemented in any application that allows creation and delivery of marketing content to users, including, but not limited to, various applications.

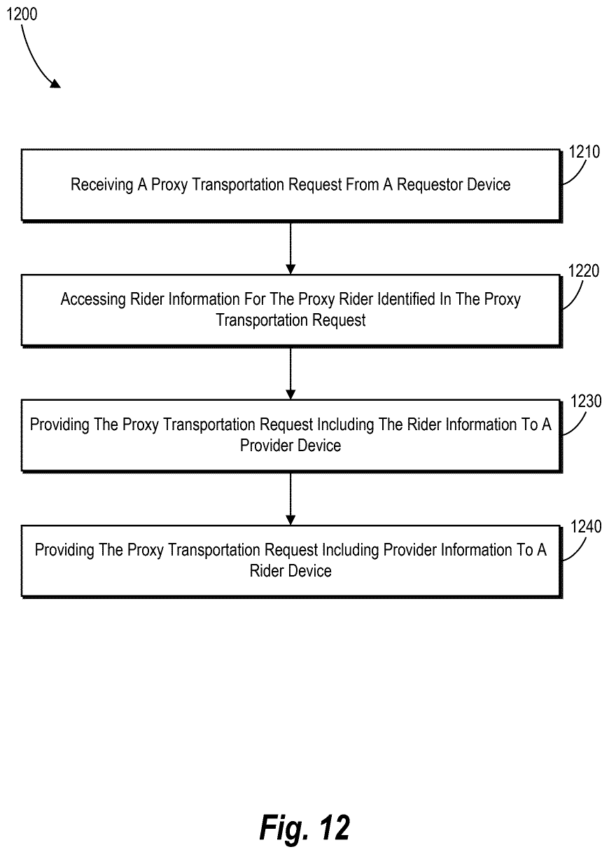

FIGS. 1-11, the corresponding text, and the examples provide a number of different systems, methods, and non-transitory computer-readable media for generating transportation requests for other users within a dynamic transportation matching system 102. In addition to the foregoing, embodiments can also be described in terms of flowcharts comprising acts for accomplishing a particular result. For example, FIG. 12 illustrates a flowchart of an example sequence of acts in accordance with one or more embodiments.

For example, FIG. 12 illustrates a flowchart of an exemplary sequence of acts 1200 for managing the allocation of transportation providers based on facilitating proxy transportation requests from a requestor device for providing a transportation service for a rider in accordance with one or more embodiments. In addition, FIG. 12 may be performed with more or fewer acts. Further, the acts may be performed in differing orders. Additionally, the acts described herein may be repeated or performed in parallel with one another or parallel with different instances of the same or similar acts.

While FIG. 12 illustrates the series of acts 1200 according to particular embodiments, alternative embodiments may omit, add to, reorder, and/or modify any of the acts shown. The series of acts 1200 can be performed as part of a method. Alternatively, a non-transitory computer-readable medium can comprise instructions, when executed by one or more processors, cause a computing device (e.g., a client device and/or a server device) to perform the series of acts of 1200. In still further embodiments, a system performs the series of acts of 1200.

As shown, the series of acts 1200 can include an act 1210 of receiving a proxy transportation request from a requestor device. For example, the act 1210 can involve receiving, at a transportation matching system, a proxy transportation request from a requestor device for providing a transportation service for a proxy rider. In one or more implementations, the act 1210 can include receiving, from the requestor device, a first identifier of the proxy rider.

In some implementations, the act 1210 can include determining that a pickup location of the proxy transportation request is beyond a proximity threshold to a current location of the requestor device; and based on the pickup location of the proxy transportation request being beyond the proximity threshold, providing, for display within a requestor user interface of the requestor device, a proxy rider notification to generate the proxy transportation request for the proxy rider rather than the requestor.

As shown, the series of acts 1200 can include an act 1220 of accessing rider information for the proxy rider identified in the proxy transportation request. For example, the act 1220 can involve accessing rider identification information corresponding to the proxy rider from a rider profile database of the transportation matching system based on the proxy transportation request from the requestor device.

In one or more implementations, the act 1220 can include identifying, based on the first identifier of the proxy rider, the rider identification information corresponding to the proxy rider from the rider profile database and identifying a second identifier of the proxy rider from the rider profile database. In some implementations, the proxy rider identification information from the rider profile database includes rider contact information that enables the provider device to directly contact the rider device.

As shown, the series of acts 1200 can include an act 1230 of providing the proxy transportation request including the rider information to a provider device. For example, the act 1230 can involve providing, for display within a provider user interface of a provider device, a first indicator of the proxy transportation request from the requestor device including the rider identification information from the rider profile database and a location of the proxy rider. In some implementations, the location of the proxy rider is based on a location received at the requestor device as part of the proxy transportation request (e.g., the indicated pickup location). In various implementations, the location of the proxy rider is based on the location of the rider device 108 (e.g., a GPS location of the rider device). For instance, the rider device has allowed the proxy matching system to access its location based on GPS, Wi-Fi, or another location-based detection service.

In one or more implementations, the act 1230 can include providing the first indicator of the transportation request by providing the second identifier of the proxy rider for display within the provider user interface of the provider device. For example, the second identifier of the proxy rider includes the name, image, number, and/or rider rating of the proxy rider as stored in the rider profile database, where the proxy rider is a registered rider in the rider profile database.

As shown, the series of acts 1200 can include an act 1240 of providing the proxy transportation request including provider information to a rider device. For example, the act 1240 can involve providing, for display within a rider user interface of a rider device associated with the proxy rider, a second indicator of the proxy transportation request from the requestor device including provider identification information and a location of the provider device. In some implementations, the location of the provider device is separate from the provider identification information.

In various implementations, the series of acts 1200 includes an additional act of providing, for display within a requestor user interface of the requestor device, real-time location information of the proxy rider during the transportation service. In some implementations, the series of acts 1200 includes additional acts of providing, for display within a requestor user interface of the requestor device, a first set of selectable transportation options and providing, for display within the rider user interface of the rider device, a second set of selectable transportation options different than the first set of selectable transportation options.

In additional implementations, the series of acts 1200 includes acts of detecting, from the requestor device, a location modification for the transportation service based on a location change option from the first set of selectable transportation options; providing, for display within the provider user interface of the provider device, the location modification for the transportation service; and providing, for display within the rider user interface of the rider device, the location modification for the transportation service. In some implementations, the first set of selectable transportation options includes selectable options that correspond to multiple transportation modes (e.g., a standard vehicle, an autonomous vehicle, a bicycle, a scooter) for providing the transportation service to the proxy rider. In various implementations, the proxy transportation request can include multiple transportation modes for the proxy rider (e.g., a ride in a vehicle followed by a scooter ride).

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 13 illustrates, in block diagram form, a computing device 1300 (e.g., an example computing device) that may be configured to perform one or more of the processes described above. One will appreciate that the proxy matching system 104 can comprise implementations of the computing device 1300, including, but not limited to, the requestor device 106, 406, 906, the rider device 108, 408, 908, the provider device 110, and/or the server device 101. As shown by FIG. 13, the computing device can comprise a processor 1302, memory 1304, a storage device 1306, an I/O interface 1308, and a communication interface 1310. In certain embodiments, the computing device 1300 can include fewer or more components than those shown in FIG. 13. Components of computing device 1300 shown in FIG. 13 will now be described in additional detail.

In particular embodiments, the processor 1302 includes hardware for executing instructions, such as those making up a computer program. As an example, and not by way of limitation, to execute instructions, the processor 1302 may retrieve (or fetch) the instructions from an internal register, an internal cache, memory 1304, or a storage device 1306 and decode and execute them.

The computing device 1300 includes memory 1304, which is coupled to the processor 1302. The memory 1304 may be used for storing data, metadata, and programs for execution by the processor 1302. The memory 1304 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1304 may be internal or distributed memory.

The computing device 1300 includes a storage device 1306 includes storage for storing data or instructions. As an example, and not by way of limitation, storage device 1306 can comprise a non-transitory storage medium described above. The storage device 1306 may include a hard disk drive (“HDD”), flash memory, a Universal Serial Bus (“USB”) drive or a combination of these or other storage devices.

The computing device 1300 also includes one or more input or output interface 1308 (or “I/O interface 1308”), which are provided to allow a user (e.g., requestor, rider, or provider) to provide input to (such as user strokes), receive output from, and otherwise transfer data to and from the computing device 1300. These I/O interface 1308 may include a mouse, keypad or a keyboard, a touch screen, camera, optical scanner, network interface, modem, other known I/O devices or a combination of the I/O interface 1308. The touch screen may be activated with a stylus or a finger.

The I/O interface 1308 may include one or more devices for presenting output to a user, including, but not limited to, a graphics engine, a display (e.g., a display screen), one or more output providers (e.g., display providers), one or more audio speakers, and one or more audio providers. In certain embodiments, interface 1308 is configured to provide graphical data to a display for presentation to a user. The graphical data may be representative of one or more graphical user interfaces and/or any other graphical content as may serve a particular implementation.

The computing device 1300 can further include a communication interface 1310. The communication interface 1310 can include hardware, software, or both. The communication interface 1310 can provide one or more interfaces for communication (such as, for example, packet-based communication) between the computing device 1300 and one or more other computing devices or one or more networks. As an example, and not by way of limitation, communication interface 1310 may include a network interface controller (“NIC”) or network adapter for communicating with an Ethernet or other wire-based network or a wireless NIC (“WNIC”) or wireless adapter for communicating with a wireless network, such as a WI-FI. The computing device 1300 can further include a bus 1312. The bus 1312 can comprise hardware, software, or both that connects components of computing device 1300 to each other.

FIG. 14 illustrates a network system 1400 (i.e., an example network environment) of the transportation matching system 102. The network system 1400 includes a client device 1406 (e.g., the requestor device 106, 406, 906, the rider device 108, 408, 908), a transportation matching system 102 implementing the proxy matching system 104, and a vehicle subsystem 1408 connected to each other by a network 1404. Although FIG. 14 illustrates a particular arrangement of the client device 1406, the transportation matching system 102, the vehicle subsystem 1408, and the network 1404, this disclosure contemplates any suitable arrangement of client device 1406, the transportation matching system 102, the vehicle subsystem 1408, and the network 1404. As an example, and not by way of limitation, two or more of client device 1406, the transportation matching system 102, and the vehicle subsystem 1408 communicate directly, bypassing the network 1404. As another example, two or more of client device 1406, the transportation matching system 102, and the vehicle subsystem 1408 may be physically or logically co-located with each other in whole or in part.

Moreover, although FIG. 14 illustrates a particular number of client devices 1406, transportation matching systems 102, vehicle subsystems 1408, and networks 1404, this disclosure contemplates any suitable number of client devices 1406, transportation matching system 102, vehicle subsystems 1408, and networks 1404. As an example, and not by way of limitation, network system 1400 may include multiple client device 1406, transportation matching system 102, vehicle subsystems 1408, and/or networks 1404.

This disclosure contemplates any suitable network. As an example, and not by way of limitation, one or more portions of the network 1404 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 1404 may include one or more networks.

Links may connect the client device 1406, the proxy matching system 104, and the vehicle subsystem 1408 to the network 1404 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network system 1400. One or more first links may differ in one or more respects from one or more second links.

In particular embodiments, the client device 1406 may be an electronic device including hardware, software, or embedded logic components or a combination of two or more such components and capable of carrying out the appropriate functionalities implemented or supported by client device 1406. As an example, and not by way of limitation, a client device 1406 may include any of the computing devices discussed above in relation to FIG. 13. A client device 1406 may enable a network user at the client device 1406 to access the network 1404. A client device 1406 may enable its user to communicate with other users at other client devices 1406.

In particular embodiments, the client device 1406 may include a requestor application, rider application, or a web browser, and may have one or more add-ons, plug-ins, or other extensions, such as a toolbar. A user at the client device 1406 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1406 one or more Hyper Text Markup Language (“HTML”) files responsive to the HTTP request. The client device 1406 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 102 may be a network-addressable computing system that can host a transportation matching network. The transportation matching system 102 may generate, store, receive, and send data, such as, for example, user-profile data, concept-profile data, text data, transportation request data, GPS location data, provider data, requestor data, rider data, vehicle data, or other suitable data related to the transportation matching network. This may include authenticating the identity of providers and/or vehicles who are authorized to provide transportation services through the transportation matching system 102. In addition, the transportation matching system 102 may manage identities of service requestors and/or riders, such as users/requestors/proxy riders. In particular, the transportation matching system 102 may maintain requestor and/or rider data such as driving/riding histories, personal data, or other user data in addition to navigation and/or traffic management services or other location services (e.g., GPS services).

In particular embodiments, the transportation matching system 102 may manage transportation matching services to connect a user/requestor/rider with a vehicle and/or provider. By managing the transportation matching services, the transportation matching system 102 can manage the distribution and allocation of resources from vehicle systems and user resources such as GPS location and availability indicators, as described herein.

The transportation matching system 102 may be accessed by the other components of network system 1400 either directly or via the network 1404. In particular embodiments, the transportation matching system 102 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1406, or a transportation matching system 102 to manage, retrieve, modify, add, or delete, the information stored in data store.

In particular embodiments, the transportation matching system 102 may provide users with the ability to take actions on various types of items or objects, supported by the transportation matching system 102. As an example, and not by way of limitation, the items and objects may include transportation matching networks to which users of the transportation matching system 102 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 102 or by an external system of a third-party system, which is separate from transportation matching system 102 and coupled to the transportation matching system 102 via a network 1404.

In particular embodiments, the transportation matching system 102 may be capable of linking a variety of entities. As an example, and not by way of limitation, the transportation matching system 102 may enable users to interact with each other or other entities, or to allow users to interact with these entities through an application programming interfaces (“API”) or other communication channels.

In particular embodiments, the transportation matching system 102 may include a variety of servers, sub-systems, programs, modules, logs, and data stores. In particular embodiments, the transportation matching system 102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile (e.g., provider profile, rider profile, or requestor profile) store, connection store, third-party content store, or location store. The transportation matching system 102 may also include suitable components such as network interfaces, security mechanisms, load balancers, failover servers, management-and-network-operations consoles, other suitable components, or any suitable combination thereof. In particular embodiments, the transportation matching system 102 may include one or more user-profile stores for storing user profiles for transportation providers, transportation riders, and/or transportation requestors. A user profile may include, for example, biographic information, demographic information, behavioral information, social information, or other types of descriptive information, such as interests, affinities, or location.

The web server may include a mail server or other messaging functionality for receiving and routing messages between the transportation matching system 102 and one or more client devices 1406. An action logger may be used to receive communications from a web server about a user's actions on or off the transportation matching system 102. In conjunction with the action log, a third-party-content-object log may be maintained of user exposures to third-party-content objects. A notification controller may provide information regarding content objects to a client device 1406. Information may be pushed to a client device 1406 as notifications, or information may be pulled from client device 1406 responsive to a request received from client device 1406. Authorization servers may be used to enforce one or more privacy settings of the users of the transportation matching system 102. A privacy setting of a user determines how particular information associated with a user can be shared. The authorization server may allow users to opt in to or opt out of having their actions logged by the transportation matching system 102 or shared with other systems, such as, for example, by setting appropriate privacy settings. Third-party-content-object stores may be used to store content objects received from third parties. Location stores may be used for storing location information received from client devices 1406 associated with users.

In addition, the vehicle subsystem 1408 can include a human-operated vehicle or an autonomous vehicle. A provider of a human-operated vehicle can perform maneuvers to pick up, transport, and drop off one or more requestors or proxy riders according to the embodiments described herein. In certain embodiments, the vehicle subsystem 1408 can include an autonomous vehicle—i.e., a vehicle that does not require a human operator. In these embodiments, the vehicle subsystem 1408 can perform maneuvers, communicate, and otherwise function without the aid of a human provider, in accordance with available technology.

In particular embodiments, the vehicle subsystem 1408 may include one or more sensors incorporated therein or associated thereto. For example, a sensor suite 1410 can be mounted on the top of the vehicle subsystem 1408 or else can be located within the interior of the vehicle subsystem 1408. In certain embodiments, the sensor suite 1410 can be located in multiple areas at once—i.e., split up throughout the vehicle subsystem 1408 so that different components of the sensor suite 1410 can be placed in different locations in accordance with optimal operation of the sensor suite 1410. In these embodiments, the sensor suite 1410 can include motion-related components such as an inertial measurement unit (“IMU”) including one or more accelerometers, one or more gyroscopes, and one or more magnetometers. The sensor suite 1410 can additionally or alternatively include a wireless IMU (“WIMU”), one or more cameras, one or more microphones, or other sensors or data input devices capable of receiving and/or recording information relating to navigating a route to pick up, transport, and/or drop off a requestor and/or proxy rider.

In particular embodiments, the vehicle subsystem 1408 may include a communication device (e.g., the provider device 110) capable of communicating with the client device 1406 and/or the proxy matching system 104. For example, the vehicle subsystem 1408 can include an on-board computing device communicatively linked to the network 1404 to transmit and receive data such as GPS location information, sensor-related information, requestor location information, rider location information, or other relevant information.

In the foregoing specification, the disclosed features have been described with reference to specific exemplary embodiments thereof. Various embodiments and aspects of the features are described with reference to details discussed herein, and the accompanying drawings illustrate the various embodiments. The description above and drawings are illustrative and are not to be construed as limiting. Numerous specific details are described to provide a thorough understanding of various embodiments of the disclosed features.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope is, therefore, indicated by the appended claims rather than by the foregoing description. All changes that come within the meaning and range of equivalency of the claims are to be embraced within their scope.

What is claimed is:

1. A method comprising:
detecting, based on user interaction with a graphical user interface of a requestor device, initiation of a transportation request;
detecting a proxy rider user interface trigger event based on at least one of: analyzing historical proxy transportation requests of the requestor device, comparing a location of a candidate proxy rider with a pickup location indicated by the user interaction, or determining, based on global position system information, that the requestor device is traveling within a vehicle;
based on detecting the proxy rider user interface trigger event, providing for display on the graphical user interface of the requestor device a proxy rider selectable element for initiating a proxy transportation request for a proxy rider corresponding to a proxy rider device;
based on user interaction with the proxy rider selectable element of the graphical user interface, initiating a proxy transportation match between the proxy rider device and a provider device; and
providing, for display, a plurality of coordinated user interfaces between the requestor device and the proxy rider device.

2. The method of claim 1, further comprising:
based on receiving from the requestor device an additional transportation request for an additional proxy rider associated with an additional proxy rider device, initiating an additional proxy transportation match between the additional proxy rider device and the provider device; and
providing, for display, the plurality of coordinated user interfaces between the requestor device and the proxy rider device and additional coordinated user interfaces between the requestor device and the additional proxy rider device.

3. The method of claim 1, further comprising:
providing, for display within a requestor user interface of the requestor device, a first set of selectable transportation options;
providing, for display within a proxy rider user interface of the proxy rider device, a second set of selectable transportation options different than the first set of selectable transportation options;
based on receiving a feature change request from the proxy rider device comprising a request for an additional selectable transportation option corresponding to an additional feature, receiving a feature change authorization from the requestor device; and
based on receiving the feature change authorization, updating the second set of selectable transportation options to include the additional selectable transportation option corresponding to the additional feature.

4. The method of claim 3, further comprising:
detecting, from the proxy rider device, a location modification for a proxy transportation service based on the additional selectable transportation option corresponding to a location change option from the updated second set of selectable transportation options;
providing, for display within a provider user interface of the provider device, the location modification for the proxy transportation service; and
providing, for display within the requestor user interface of the requestor device and the proxy rider user interface of the proxy rider device, the location modification for the proxy transportation service.

5. The method of claim 1, further comprising:
identifying a proxy rider list comprising one or more proxy riders associated with a requestor of the requestor device;
receiving a removal request from the proxy rider device for removal of the proxy rider from the proxy rider list associated with the requestor of the requestor device; and
in response to receiving the removal request, removing the proxy rider from the proxy rider list associated with the requestor of the requestor device.

6. The method of claim 1, wherein analyzing historical proxy transportation requests of the requestor device comprises detecting a day and time pattern of the requestor device submitting prior proxy transportation requests for the proxy rider.

7. The method of claim 1, wherein comparing a location of a candidate proxy rider with a pickup location indicated by the user interaction comprises:
identifying locations of proxy rider devices of proxy riders on a proxy rider list associated with the requestor device; and
determining that the location of the proxy rider falls within a threshold pickup distance of the pickup location.

8. A system comprising:
at least one processor; and
a non-transitory computer-readable medium comprising instructions that, when executed by the at least one processor, cause the system to:
detect, based on user interaction with a graphical user interface of a requestor device, initiation of a transportation request;
detect a proxy rider user interface trigger event based on at least one of: analyzing historical proxy transportation requests of the requestor device, comparing a location of a candidate proxy rider with a pickup location indicated by the user interaction, or determining, based on global position system information, that the requestor device is traveling within a vehicle;
based on detecting the proxy rider user interface trigger event, provide for display on the graphical user interface of the requestor device a proxy rider selectable element for initiating a proxy transportation request for a proxy rider corresponding to a proxy rider device;
based on user interaction with the proxy rider selectable element of the graphical user interface, initiate a proxy transportation match between the proxy rider device and a provider device; and
provide, for display, a plurality of coordinated user interfaces between the requestor device and the proxy rider device.

9. The system of claim 8, further comprising instructions that, when executed by the at least one processor, cause the system to:
based on receiving from the requestor device an additional transportation request for an additional proxy rider associated with an additional proxy rider device, initiate an additional proxy transportation match between the additional proxy rider device and the provider device; and
provide, for display, the plurality of coordinated user interfaces between the requestor device and the proxy rider device and additional coordinated user interfaces between the requestor device and the additional proxy rider device.

10. The system of claim 8, further comprising instructions that, when executed by the at least one processor, cause the system to:
provide, for display within a requestor user interface of the requestor device, a first set of selectable transportation options;
provide, for display within a proxy rider user interface of the proxy rider device, a second set of selectable transportation options different than the first set of selectable transportation options;
based on receiving a feature change request from the proxy rider device comprising a request for an additional selectable transportation option corresponding to an additional feature, receive a feature change authorization from the requestor device; and
based on receiving the feature change authorization, update the second set of selectable transportation options to include the additional selectable transportation option corresponding to the additional feature.

11. The system of claim 10, further comprising instructions that, when executed by the at least one processor, cause the system to:
detect, from the proxy rider device, a location modification for a proxy transportation service based on the additional selectable transportation option corresponding to a location change option from the updated second set of selectable transportation options;
provide, for display within a provider user interface of the provider device, the location modification for the proxy transportation service; and
provide, for display within the requestor user interface of the requestor device and the proxy rider user interface of the proxy rider device, the location modification for the proxy transportation service.

12. The system of claim 8, further comprising instructions that, when executed by the at least one processor, cause the system to:
identify a proxy rider list comprising one or more proxy riders associated with a requestor of the requestor device;
receive a removal request from the proxy rider device for removal of the proxy rider from the proxy rider list associated with the requestor of the requestor device; and
in response to receiving the removal request, remove the proxy rider from the proxy rider list associated with the requestor of the requestor device.

13. The system of claim 8, wherein analyzing historical proxy transportation requests of the requestor device comprises detecting a day and time pattern of the requestor device submitting prior proxy transportation requests for the proxy rider.

14. The system of claim 8, wherein comparing a location of a candidate proxy rider with a pickup location indicated by the user interaction comprises:
identifying locations of proxy rider devices of proxy riders on a proxy rider list associated with the requestor device; and
determining that the location of the proxy rider falls within a threshold pickup distance of the pickup location.

15. A non-transitory computer-readable medium comprising instructions that, when executed by at least one processor, cause a computing device to:
detect, based on user interaction with a graphical user interface of a requestor device, initiation of a transportation request;
detect a proxy rider user interface trigger event based on at least one of: analyzing historical proxy transportation requests of the requestor device, comparing a location of a candidate proxy rider with a pickup location indicated by the user interaction, or determining, based on global position system information, that the requestor device is traveling within a vehicle;
based on detecting the proxy rider user interface trigger event, provide for display on the graphical user interface of the requestor device a proxy rider selectable element for initiating a proxy transportation request for a proxy rider corresponding to a proxy rider device;
based on user interaction with the proxy rider selectable element of the graphical user interface, initiate a proxy transportation match between the proxy rider device and a provider device; and
provide, for display, a plurality of coordinated user interfaces between the requestor device and the proxy rider device.

16. The non-transitory computer-readable medium of claim 15, further comprising instructions that, when executed by the at least one processor, cause the computing device to:
based on receiving from the requestor device an additional transportation request for an additional proxy rider associated with an additional proxy rider device, initiate an additional proxy transportation match between the additional proxy rider device and the provider device; and
provide, for display, the plurality of coordinated user interfaces between the requestor device and the proxy rider device and additional coordinated user interfaces between the requestor device and the additional proxy rider device.

17. The non-transitory computer-readable medium of claim 15, further comprising instructions that, when executed by the at least one processor, cause the computing device to:
provide, for display within a requestor user interface of the requestor device, a first set of selectable transportation options;
provide, for display within a proxy rider user interface of the proxy rider device, a second set of selectable transportation options different than the first set of selectable transportation options;
based on receiving a feature change request from the proxy rider device comprising a request for an additional selectable transportation option corresponding to an additional feature, receive a feature change authorization from the requestor device; and
based on receiving the feature change authorization, update the second set of selectable transportation options to include the additional selectable transportation option corresponding to the additional feature.

18. The non-transitory computer-readable medium of claim 17, further comprising instructions that, when executed by the at least one processor, cause the computing device to:
detect, from the proxy rider device, a location modification for a proxy transportation service based on the additional selectable transportation option corresponding to a location change option from the updated second set of selectable transportation options;
provide, for display within a provider user interface of the provider device, the location modification for the proxy transportation service; and
provide, for display within the requestor user interface of the requestor device and the proxy rider user interface of the proxy rider device, the location modification for the proxy transportation service.

19. The non-transitory computer-readable medium of claim 15, further comprising instructions that, when executed by the at least one processor, cause the computing device to:
identify a proxy rider list comprising one or more proxy riders associated with a requestor of the requestor device;
receive a removal request from the proxy rider device for removal of the proxy rider from the proxy rider list associated with the requestor of the requestor device; and
in response to receiving the removal request, remove the proxy rider from the proxy rider list associated with the requestor of the requestor device.

20. The non-transitory computer-readable medium of claim 15, wherein analyzing historical proxy transportation requests of the requestor device comprises detecting a day and time pattern of the requestor device submitting prior proxy transportation requests for the proxy rider.
